(19) United States
(12) Patent Application Publication
(10) Pub. No.: US 2024/0060272 A1
(43) Pub. Date: Feb. 22, 2024

(54) WORK VEHICLE AND SPEED CONTROL METHOD FOR WORK VEHICLE

(71) Applicant: KUBOTA CORPORATION, Osaka-shi (JP)

(72) Inventors: Kohei NAGAO, Sakai-shi (JP); Ryota HAMAMOTO, Sakai-shi (JP)

(73) Assignee: KUBOTA CORPORATION, Osaka-shi (JP)

(21) Appl. No.: 18/362,964

(22) Filed: Aug. 1, 2023

(30) Foreign Application Priority Data
Aug. 19, 2022 (JP) 2022-131193

(51) Int. Cl. E02F 9/22

(52) U.S. Cl. CPC E02F 9/2235; E02F 9/2203

(57) ABSTRACT

A speed control method for a work vehicle includes controlling a first hydraulic pump to supply hydraulic fluid to a first hydraulic motor to drive a first traveling device provided on a vehicle body of the work vehicle and detecting a first differential pressure of the first hydraulic motor. The method includes regulating at least one of a first pump pilot pressure applied to a first pump pilot port of the first hydraulic pump and a rotational speed of an engine to drive the first hydraulic pump such that a vehicle speed is controlled to maintain a predetermined target speed in response to an absolute value of the first differential pressure.

### CROSS-REFERENCE TO RELATED APPLICATIONS

The present application claims priority under 35 U. S. C. § 119 to Japanese Patent Application No. 2022-131193, filed Aug. 19, 2022. The contents of this application are incorporated herein by reference in their entirety.

### BACKGROUND OF THE INVENTION

### Field of the Invention

The present invention relates to a work vehicle and a speed control method for the work vehicle.

### Discussion of the Background

Japanese Patent Application Laid-Open No. 2017-053413 discloses a technique for limiting a primary pilot pressure of an oil passage between a pilot pump and an operation valve operated by a travel lever when limiting a traveling speed of a work vehicle. Japanese Patent No. 6695791 discloses a technique for limiting a secondary pilot pressure of an oil passage between an operation valve operated by a travel lever ahead and a hydraulic pump for traveling when limiting the travel speed of a work vehicle.

### SUMMARY OF THE INVENTION

According to one aspect of the present disclosure, a speed control method for a work vehicle includes controlling a first hydraulic pump to supply hydraulic fluid to a first hydraulic motor to drive a first traveling device provided on a vehicle body of the work vehicle, detecting a first differential pressure of the first hydraulic motor; and regulating at least one of a first pump pilot pressure applied to a first pump pilot port of the first hydraulic pump and a rotational speed of an engine to drive the first hydraulic pump such that a vehicle speed is controlled to maintain a predetermined target speed in response to an absolute value of the first differential pressure.

According to another aspect of the present disclosure, a work vehicle includes a vehicle body, a first traveling device provided on the vehicle body, a first hydraulic motor having a first motor pilot port and configured to drive the first traveling device in response to a first motor pilot pressure applied to the first motor pilot port, a first hydraulic pump having a first pump pilot port and configured to supply hydraulic fluid to the first hydraulic motor in response to a first pump pilot pressure applied to the first pump pilot port, a first oil passage and a second oil passage which connect the first hydraulic pump and the first hydraulic motor and through which the hydraulic fluid is supplied, a first hydraulic pressure sensor configured to detect a first hydraulic pressure in the first oil passage, a second hydraulic pressure sensor configured to detect a second hydraulic pressure in the second oil passage, a pilot pump configured to supply pilot oil to the first pump pilot port, an engine configured to drive the first hydraulic pump and the pilot pump, and control circuitry configured to obtain an absolute value of a first differential pressure, which is a difference between the first hydraulic pressure and the second hydraulic pressure, the control circuitry being configured to regulate at least one of the first pump pilot pressure and a rotational speed of the engine such that a vehicle speed is controlled to maintain a predetermined target speed according to the absolute value of the first differential pressure.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings.

FIG. 1 is a side view of a work vehicle.

FIG. 2 is a top view of the work vehicle.

FIG. 3 is a hydraulic circuit diagram of a travel system of the work vehicle according to the first embodiment.

FIG. 4 is a diagram showing a relationship between an engine rotational speed, a primary pilot pressure, and a set line.

FIG. 5 is a diagram showing the relationship between the operating position of the operation lever and the secondary pilot pressure.

FIG. 6 is a block diagram of the work vehicle.

FIG. 7 shows an example of third reference information in the first embodiment and the second embodiment.

FIG. 8 is a flowchart showing the operation of the work vehicle according to the first embodiment.

FIG. 9 is a hydraulic circuit diagram of a travel system of a work vehicle according to a second embodiment.

FIG. 10 is a flowchart showing an operation of a work vehicle according to a second embodiment.

FIG. 11 is a hydraulic circuit diagram of a travel system of a work vehicle in a modification of the second embodiment.

FIG. 12 shows an example of third reference information in a third embodiment.

FIG. 13 shows an example of fourth reference information in a third embodiment.

FIG. 14A is a flowchart showing the operation of the work vehicle according to the third embodiment.

FIG. 14B is a flowchart showing the operation of the work vehicle according to the third embodiment.

FIG. 15 is a hydraulic circuit diagram of a travel system of a work vehicle according to a fourth embodiment.

FIG. 16 shows an example of third reference information in the fourth embodiment.

FIG. 17 is a flowchart showing an operation of a work vehicle according to a fourth embodiment.

### DESCRIPTION OF THE EMBODIMENTS

Hereinafter, the present invention will be described in detail with reference to the drawings showing embodiments thereof. In the drawings, the same reference numerals denote corresponding or substantially identical configurations.

### First Embodiment

### <Overall Configuration>

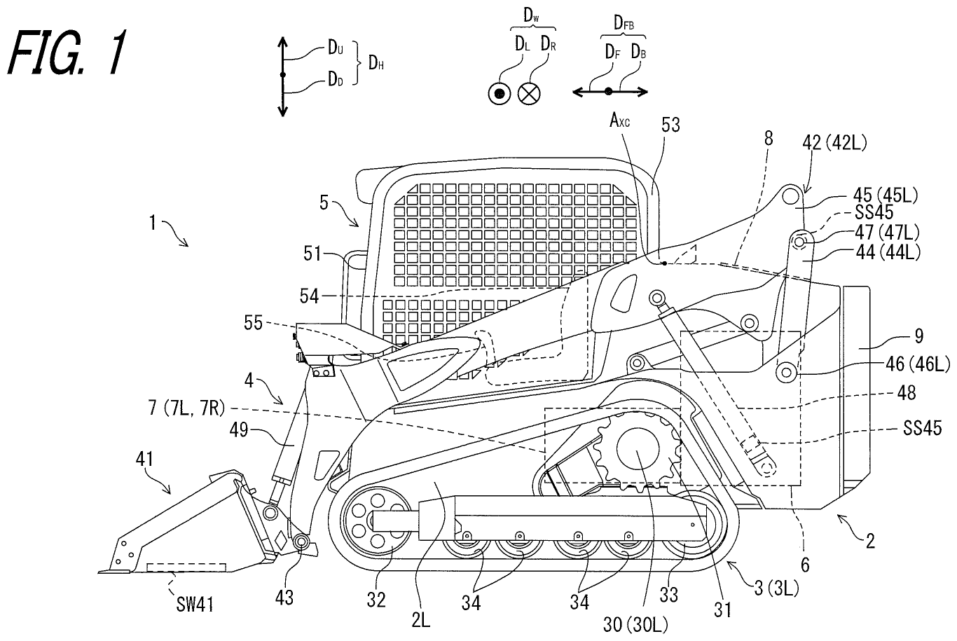

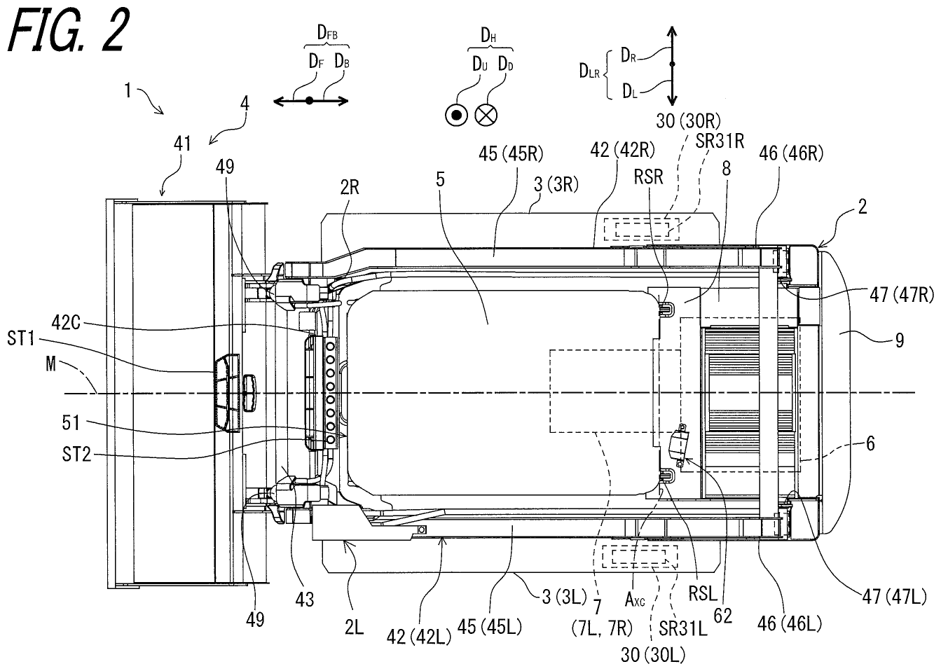

Referring to FIGS. 1 and 2, a work vehicle 1, such as a compact truck loader, includes a vehicle body 2, a pair of traveling devices 3, and a work device 4. The vehicle body 2 supports traveling devices 3 and a work device 4. In the illustrated embodiment, the traveling devices 3 are crawler type traveling devices provided in the vehicle body 2. Therefore, each of the pair of traveling devices 3 includes a drive wheel 31 driven by each of the hydraulic motor devices 30, driven wheels 32 and 33, and a rolling wheel 34. However, each of the pair of traveling devices 3 is not limited to a crawler type traveling device. Each of the pair of traveling devices 3 may be, for example, a front wheel/rear wheel traveling device, or a traveling device having a front wheel and a rear crawler. The work device 4 includes a work equipment (bucket) 41 at the distal end of the work device 4. The proximal end of the work device 4 is attached to the rear portion of the vehicle body 2. The work device 4 includes a pair of arm assemblies 42 for rotatably supporting the bucket 41 via a bucket pivot shaft 43. Each of the pair of arm assemblies 42 includes a link 44 and an arm 45.

The link 44 is rotatable with respect to the vehicle body 2 about a fulcrum shaft 46. The arm 45 is rotatable with respect to the link 44 about a joint shaft 47. The work device 4 further includes a plurality of arm cylinders 48 and at least one equipment cylinder 49. Each of the plurality of arm cylinders 48 is rotatably connected to the vehicle body 2 and the arm 45, and moves the link 44, the arm 45 and the like to lift and lower the bucket 41. The at least one equipment cylinder 49 is configured to tilt the bucket 41. The vehicle body 2 includes a cabin 5. The cabin 5 is provided with a front window 51 which can be opened and closed, and an outer shape thereof is defined by a cab frame 53. The front window 51 may be omitted. A work vehicle includes a driver seat 54 and operation lever 55 in a cabin 5. As shown in FIG. 2, the cab frame 53 is rotatable about rotational shafts RSL and RSR on the vehicle body 2. In FIGS. 1 and 2, a common pivot A_{XC} defined by the rotational shaft RSL and RSR is illustrated. That is, the cab frame 53 is attached to the vehicle body 2 so as to be rotatable about a pivot A_{XC}.

In the embodiment according to the present application, a front-back direction D_{FB} (forward direction D_{F}/backward direction D_{B}) means a front-back direction (forward direction/backward direction) as seen from an operator seated on the driver seat 54 of the cabin 5. A leftward direction D_{L}, a rightward direction D_{R}, a width direction D_{W} means the left direction, the right direction, and the left-right direction as viewed from the operator, respectively. An upward direction D_{U}, a downward direction D_{D}, height direction D_{H} means an upward direction, a downward direction, and a height direction as viewed from the operator. The front-back, left-right (width), and up-down (height) directions of the work vehicle 1 coincide with the front-back, left-right (width), and up-down (height) directions as viewed from the operator, respectively.

FIG. 1 shows the left side of the work vehicle 1. As shown in FIG. 2, the vehicle body 2 is substantially plane-symmetric with respect to the vehicle body center surface M, and is a first side surface 2L which is a left side surface and a second side surface 2R which is a right side face. Among the pair of traveling devices 3, a traveling device 3 provided on the first side surface 2L is shown as the left traveling device 3L, and a traveling device 3 provided on the second side surface 2R is shown as the right traveling device 3R. Among the pair of arm assemblies 42, an arm assembly 42 provided on the left side with respect to the vehicle body center surface M is shown as the first arm assembly 42L, and an arm assembly 42 provided on the right side with respect to the vehicle body center surface M is shown as the second arm assembly 42R. The link 44 provided on the left side of the vehicle body center surface M is shown as a first link 44L. An arm 45 provided on the left side of the vehicle body center surface M is shown as a first arm 45L, and an arm 45 provided on the right side of the vehicle body center surface M is shown as a second arm 45R. The fulcrum shaft 46 provided on the left side of the vehicle body center surface M is shown as the first fulcrum shaft 46L. The fulcrum shaft 46 provided on the right side with respect to the vehicle body center surface M is shown as a second fulcrum shaft 46R. The joint shaft 47 provided on the left side with respect to the vehicle body center surface M is shown as a first joint shaft 47L, and the joint shaft 47 provided on the right side with respect to the vehicle body center surface M is shown as a second joint shaft 47R. Among the hydraulic motor devices 30, a hydraulic motor device 30 provided on the left side with respect to the vehicle body center surface M is shown as a left hydraulic motor device 30L. A hydraulic motor device 30 provided on the right side with respect to the vehicle body center surface M is shown as a right hydraulic motor device 30R.

Referring to FIGS. 1 and 2, the work vehicle 1 includes an engine 6 and provided at a rear portion of the vehicle body 2, and a plurality of hydraulic pumps including the left hydraulic pump7L and the right hydraulic pump 7R. The engine 6 drives a plurality of hydraulic pumps 7. The left hydraulic pump 7L and the right hydraulic pump 7R are configured to discharge hydraulic fluid for driving hydraulic motor devices 30 for driving the drive wheel 31. The left hydraulic pump 7L and the right hydraulic pump 7R are collectively referred to as hydraulic pumps 7L, 7R. The plurality of hydraulic pumps 7 other than the left hydraulic pump 7L and the right hydraulic pump 7R is hydraulic pump configured to discharge hydraulic fluid for driving a hydraulic actuator (a plurality of arm cylinders 48, at least one equipment cylinder 49, or the like) connected to the work device 4. The engine 6 is provided between a pair of arm assemblies 42 in the width direction DW of the work vehicle 1. The work vehicle 1 further includes a cover 8 for covering the engine 6. The work vehicle 1 further includes a bonnet cover 9 provided at the rear end of the vehicle body 2. The bonnet cover 9 is openable and closable such that a maintenance personnel can perform maintenance work on the engine 6 and the like.

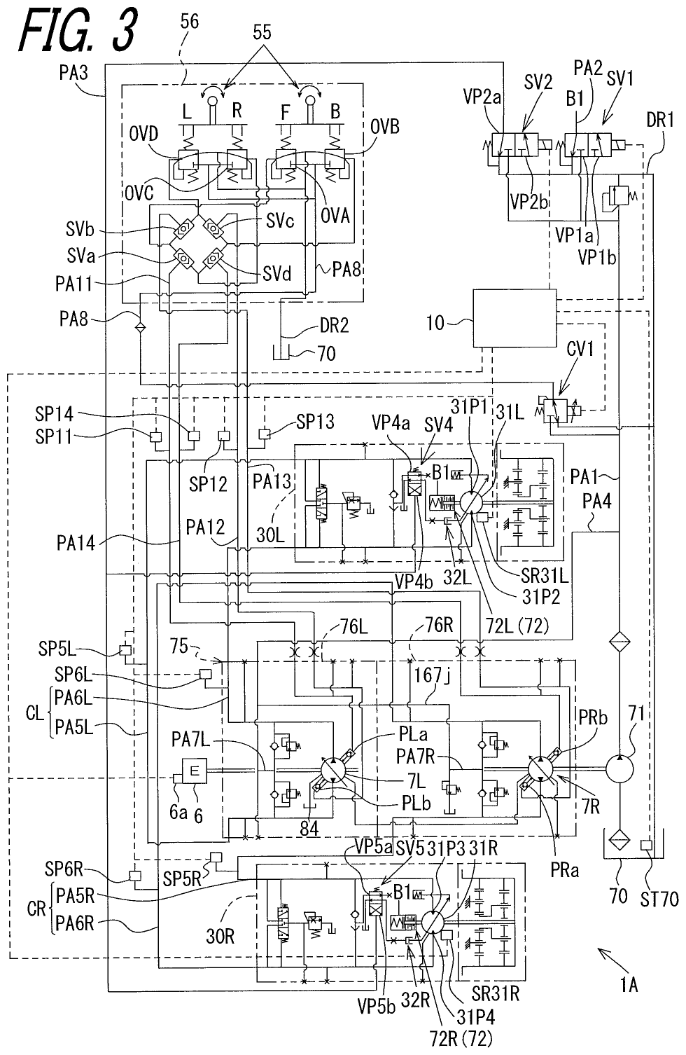

FIG. 3 is a hydraulic circuit diagram of a travel system of the work vehicle 1 according to the first embodiment. The work vehicle includes a hydraulic circuit 1A. The hydraulic circuit 1A includes a hydraulic fluid tank 70 and a pilot pump 71. The pilot pump 71 is a constant displacement gear pump driven by the power of the engine 6. The pilot pump 71 is configured to discharge the hydraulic fluid stored in the hydraulic fluid tank 70. In particular, the pilot pump 71 is configured to discharge a hydraulic fluid mainly used for control. For convenience of explanation, among the hydraulic fluid discharged from the pilot pump 71, the hydraulic fluid used for control is referred to as pilot oil, and the pressure of the pilot oil is referred to as pilot pressure. In particular, the pilot pump 71 is configured to supply pilot oil to a left hydraulic pump 7L and a right hydraulic pump 7R.

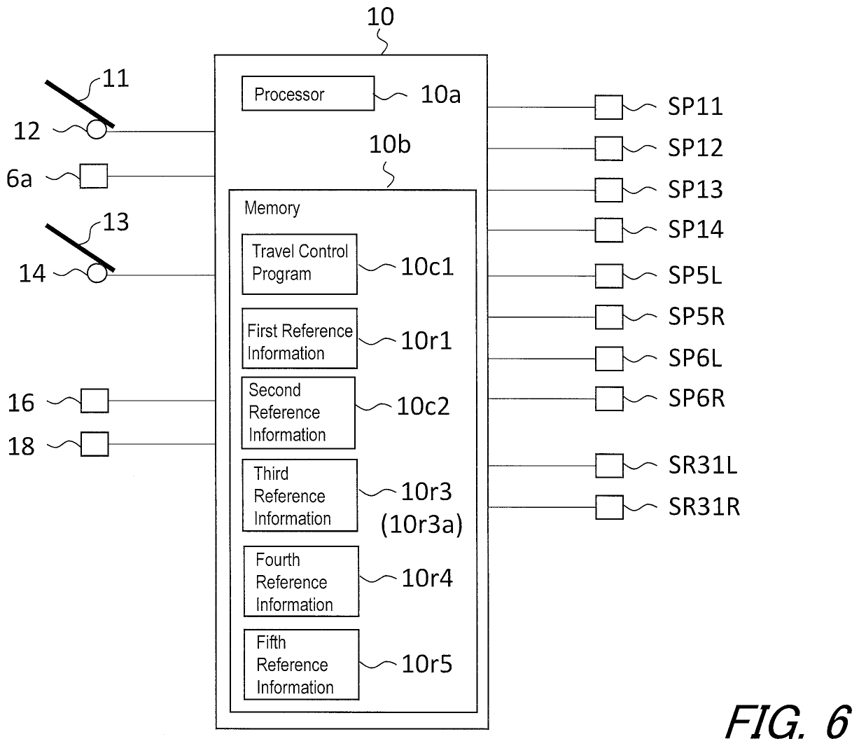

The hydraulic circuit 1A includes a pilot supply oil passage PA1 connected to a discharge port of a pilot pump 71. The pilot oil shall be supplied in the pilot supply oil passage PAL The hydraulic circuit 1A includes a plurality of switching valves (brake switching valves, direction switching valve SV2) connected to the pilot supply oil passage PA1, and a plurality of brake mechanisms 72. The brake switching valve SV1 is connected to the pilot supply oil passage PAL The brake switching valve SV1 is a direction switching valve (solenoid valve) for braking and releasing braking by the plurality of brake mechanisms 72. The brake switching valve SV1 is a two-position switching valve configured to switch a valve element to the first position VP1a and the second position VP1b by exciting. Switching of the valve element of the brake switching valve SV1 is performed by the brake pedal 13 (see FIG. 6). The brake pedal 13 is provided with a sensor 14. The operation amount detected by the sensor 14 is input to a controller (control circuitry) 10 composed of an ECU (Electric Control Unit). The controller 10 may be referred to as a control device.

The plurality of brake mechanisms 72 include a first brake mechanism 72L for braking the left traveling device 3L and a second brake mechanism 72R for braking the right traveling device 3R. The first brake mechanism 72L and the second brake mechanism 72R are connected to the brake switching valve via an oil passage PA2. The first brake mechanism 72L and the second brake mechanism 72R are configured to brake the traveling devices 3 according to the pressure of the pilot oil (hydraulic fluid). When the valve element of the brake switching valve SV1 is switched to the first position VP1a, the hydraulic fluid is released from the oil passage PA2 in the section between the brake switching valve SV1 and the brake mechanisms 72, and the traveling devices 3 are braked by the brake mechanisms 72. When the valve element of the brake switching valve SV1 is switched to the second position VP1b, the braking by the brake mechanisms 72 is released. When the valve element of the brake switching valve SV1 is switched to the first position VP1a, the braking by the brake mechanisms 72 is released, and when the valve element of the brake switching valve SV1 is switched to the second position VP1b, the traveling devices 3 may be braked by the brake mechanisms 72.

The direction switching valve SV2 is an electromagnetic valve for changing the rotation of the left hydraulic motor device 30L and the right hydraulic motor device 30R. The direction switching valve SV2 is a two-position switching valve configured to switch a valve element to the first position VP2a or second position VP2b by excitation. Switching of the direction switching valve SV2 is performed by an operating member (not illustrated) or the like. The direction switching valve SV2 may be a proportional valve capable of adjusting the flow rate of the hydraulic fluid to be discharged, instead of a two-position switching valve.

The left hydraulic motor device 30L is a device for transmitting power to drive wheel 31 provided in the left traveling device 3L. The left hydraulic motor device 30L includes a left hydraulic motor 31L, a first swash plate switching cylinder 32L, and a first travel control valve (hydraulic switching valve) SV4. The left hydraulic motor 31L is a swash plate type variable capacity axial motor for driving the left traveling device 3L, and is a motor capable of changing the vehicle speed (rotation) to the first or second speed. The first swash plate switching cylinder 32L is configured to change the angle of the swash plate of the left hydraulic motor 31L by expansion and contraction. The first travel control valve SV4 expands and contracts the first swash plate switching cylinder 32L. The first travel control valve SV4 is a two-position switching valve configured to switch its valve element between the first position VP4a and the second position VP4b.

Switching of the first travel control valve SV4 is performed by a direction switching valve SV2 located on the upstream side and connected to the first travel control valve SV4. Specifically, the direction switching valve SV2 and the first travel control valve SV4 is connected by the oil passage PA3 and the switching operation of the first travel control valve SV4 is performed by hydraulic fluid flowing through the oil passage PA3. For example, the valve element of the direction switching valve SV2 is switched to the first position VP2a, the pilot oil is released in the section between the direction switching valve SV2 and the first travel control valve SV4, and the valve element of the first travel control valve SV4 is switched to the first position VP4a. As a result, the first swash plate switching cylinder 32L contracts, and the speed of the left hydraulic motor 31L is changed to the first speed. When the valve element of the direction switching valve SV2 is switched to the second position VP2b by the operation of the operating member, the pilot oil is supplied to the first travel control valve SV4 through the direction switching valve SV2, and the valve element of the first travel control valve SV4 is switched to the second position VP4b. As a result, the first swash plate switching cylinder 32L is extended, and the speed of the left hydraulic motor 31L is changed to the second speed.

The right hydraulic motor device 30R is a device for transmitting power to the drive wheel 31 provided in the right traveling device 3R. The right hydraulic motor device 30R includes a right hydraulic motor 31R, a second swash plate switching cylinder 32R, and a second travel control valve (hydraulic switching valve). The right hydraulic motor device 30R is a hydraulic motor for driving the right traveling device 3R, and operates similarly to the left hydraulic motor device 30L. That is, the right hydraulic motor 31R operates in the same manner as the left hydraulic motor 31L. The left hydraulic motor 31L and the right hydraulic motor 31R are collectively referred to as hydraulic motors (31L, 31R). The second swash plate switching cylinder 32R operates in the same manner as the first swash plate switching cylinder 32L. The second travel control valve SV5 is a two-position switching valve configured to switch its valve element between the first position VP5a and the second position VP5b, and operates in the same manner as the first travel control valve SV4.

A drain oil passage DR1 is connected to the hydraulic circuit 1A. The drain oil passage DR1 is an oil passage to make the pilot oil flow from a plurality of the switching valves (a brake switching valve SV1 and a direction switching valve SV2) to the hydraulic fluid tank 70. For example, the drain oil passage DR1 is connected to a discharge port of a plurality of switching valves (a brake switching valve SV1 and a direction switching valve SV2). That is, when the brake switching valve SV1 is at the first position VP1a, the hydraulic fluid is discharged from the oil passage PA2 to the drain oil passage DR1 in the interval between the brake switching valve SV1 and the brake mechanisms 72. When the direction switching valve SV2 is located at the first position VP1a, the pilot oil in the oil passage PA3 is discharged to the drain oil passage DR1.

The hydraulic circuit 1A further includes a first charge oil passage PA4 and a hydraulic drive device 75. The first charge oil passage PA4 is branched from the pilot supply oil passage PA1 and connected to the hydraulic drive device 75. The hydraulic drive device 75 drives the left hydraulic motor device 30L and the right hydraulic motor device 30R. The hydraulic drive device 75 includes a first drive circuit 76L for driving the left hydraulic motor device 30L and a second drive circuit 76R for driving the right hydraulic motor device 30R.

The first drive circuit 76L includes a left hydraulic pump 7L and drive oil passages PA5L, PA6L and a second charge oil passage PA7L. The drive oil passages PA5L and PA6L are oil passages for connecting the left hydraulic pump 7L and the left hydraulic motor 31L. A hydraulic circuit formed by the drive oil passages PA5L and PA6L is referred to as a left hydraulic circuit CL. The second charge oil passage PA7L, which is connected to the drive oil passages PA5L and PA6L is an oil passage for replenishing the drive oil passages PA5L and PA6L with the hydraulic fluid from the pilot pump 71. The left hydraulic motor 31L has a first connection port 31P1 connected to the drive oil passage PA5L and a second connection port 31P2 connected to the drive oil passage PA6L. Hydraulic fluid for rotating the left traveling device 3L in the forward direction is input to the left hydraulic motor 31L via the first connection port 31P1, and hydraulic fluid for rotating the left traveling device 3L in the backward direction is discharged from the left hydraulic motor 31L via the first connection port 31P1. Hydraulic fluid for rotating the left traveling device 3L in the backward direction is input to the left hydraulic motor 31L via the second connection port 31P2, and hydraulic fluid for rotating the left traveling device 3L in the forward direction is discharged from the left traveling device 3L.

Similarly, the second drive circuit 76R includes a right hydraulic pump 7R, drive oil passages PA5R and PA6R, and a third charge oil passage PA7R. The drive oil passages PA5R and PA6R are oil passages connecting the right hydraulic pump 7R and the right hydraulic motor 31R. A hydraulic circuit formed by drive oil passages PA5R and PA6R is referred to as a right hydraulic circuit CR. The third charge oil passage PA7R is an oil passage which is connected to the drive oil passages PA5R and PA6R and replenishes the drive oil passages PA5R and PA6R with the hydraulic fluid from the pilot pump 71. The right hydraulic motor 31R includes a third connection port 31P3 for connecting to the drive oil passage PA5R, and a fourth connection port 31P4 for connecting to the drive oil passage PA6R. The hydraulic fluid for rotating the right traveling device 3R in the forward direction is input to the right hydraulic motor 31R through the third connection port 31P3, and the hydraulic fluid for rotating the right traveling device 3R in the backward direction is discharged from the right hydraulic motor 31R through the third connection port 31P3. The hydraulic fluid for rotating the right traveling device 3R in the backward direction is input to the right hydraulic motor 31R through the fourth connection port 31P4, and hydraulic fluid for rotating the right traveling device 3R in the forward direction is discharged from the right traveling device 3R. That is, the hydraulic motors 31L, 31R are configured to drive the traveling devices 3L, 3R. The hydraulic pumps 7L, 7R are configured to discharge hydraulic fluid for driving hydraulic motors 31L, 31R. The drive oil passages PA5L, PA6L, PA5R, PA6R are oil passages that connect hydraulic pumps 7L, 7R and hydraulic motors 31L, 31R.

The left hydraulic pump 7L and right hydraulic pump 7R are swash plate type variable capacity axial pump which is driven by the power of the engine 6. The left hydraulic pump 7L which is connected to the left hydraulic motor 31L via the left hydraulic circuit CL includes a first port PLa and a second port PLb to which the pilot pressure acts. The left hydraulic pump 7L is configured to change the angle of the swash plate in accordance with the pilot pressure acting on the first port PLa and a second port PLb, and supply the hydraulic fluid to the left hydraulic motor 31L. Specifically, the left hydraulic pump 7L supplies hydraulic fluid to the left hydraulic motor 31L via a left hydraulic circuit CL so as to drive a left traveling device 3L forward when the hydraulic pressure applied to a second port PLb is higher than the hydraulic pressure applied to a first port PLa, and the left hydraulic pump 7L supplies hydraulic fluid to the left hydraulic motor 31L via a left hydraulic circuit CL so as to drive the left traveling device 3L backward when the hydraulic pressure applied to a second port PLb is higher than the hydraulic pressure applied to a first port PLa.

The right hydraulic pump 7R which is connected to the right hydraulic motor 31R via the right hydraulic circuit CR, includes a third port PRa and a fourth port PRb to which the pilot pressure acts. Specifically, the right hydraulic pump 7R is configured such that when the hydraulic pressure applied to the third port PRa is higher than the hydraulic pressure applied to the fourth port PRb, the right hydraulic pump 7R supplies hydraulic fluid to the right hydraulic motor 31R via a right hydraulic circuit CR so as to drive the right traveling device 3R forward, and when the hydraulic pressure applied to the fourth port PRb is higher than the hydraulic pressure applied to the third port PRa, the right hydraulic pump 7R supplies hydraulic fluid to the right hydraulic motor 31R via a right hydraulic circuit CR so as to drive the right traveling device 3R backward. The left hydraulic pump 7L and the right hydraulic pump 7R can change the output (discharge amount of the hydraulic fluid) and the discharge direction of the hydraulic fluid in accordance with the angle of the swash plate.

The output of the left hydraulic pump 7L and the right hydraulic pump 7R and the discharge direction of the hydraulic fluid are changed by the operation device 56 for operating the traveling direction of the work vehicle 1. Specifically, the outputs of the left hydraulic pump 7L and the right hydraulic pump 7R and the discharge direction of the hydraulic fluid are changed in accordance with the operation of the operation lever 55 provided in the operation device 56. In other words, the operation device 56 is a device configured to select at least one of the left traveling device 3L and the right traveling device 3R, and to operate the traveling direction of the work vehicle by instructing at least one of the traveling devices to move forward or backward. An instruction of the traveling direction is input by the user via the operation lever 55. The operation lever 55 may be referred to as a travel instruction input device.

As shown in FIG. 3, the hydraulic circuit 1A includes as pilot supply passage PA8 which is branched from the pilot supply oil passage PA1 and connected to the operation device 56, and a primary pressure control valve CV1 provided on a pilot supply oil passage PA8). In the following embodiments, the pilot supply oil passage PA1 and the pilot supply oil passage PA8 are collectively referred to as a primary pilot oil passage. The primary pressure control valve CV1 is an electromagnetic proportional valve including a solenoid, and is configured to adjust the pilot pressure supplied to the operation device 56 by adjusting the opening degree in accordance with the current applied to the solenoid. The opening degree of the primary pressure control valve CV1 is controlled by the current supplied from the controller 10. In some cases, the pilot pressure output from the primary pressure control valve CV1 increases as the magnitude of the current increases, and in other cases, the pilot pressure output from the primary pressure control valve CV1 decreases as the magnitude of the current increases. In the following embodiments, the primary pressure control valve CV1 may be referred to as a hydraulic pressure adjusting mechanism. The detailed operation of the primary pressure control valve CV1 will be described later.

The operation device 56 includes can operation valve OVA for forward movement, an operation valve OVB for backward movement, an operation valve OVC for right turning, an operation valve OVD for left turning, and operation lever 55. The operation device 56 has first to fourth shuttle valves SVa, SVb, SVc, and SVd. The operation valves OVA, OVB, OVC, and OVD are operated by a single operation lever 55. The operation valves OVA, OVB, OVC, and OVD change the pressure of the hydraulic fluid in accordance with the operation of the operation lever 55, and the changed hydraulic fluid is transferred to the first port PLa and the second port PLb of the left hydraulic pump 7L and the third port PRa and the fourth port PRb of the right hydraulic pump 7R. Although the operation valves OVA, OVB, OVC, and OVD are operated by a single operation lever 55 in this embodiment, a plurality of operation levers 55 may be used. In the following embodiments, one or a plurality of operation levers 55 may be referred to as a first operation device.

Each of the operation valves OVA, OVB, OVC, and OVD has an input port (primary port), an discharge port, and an output port (secondary port). As shown in FIG. 3, the input port is connected to the pilot supply oil passage PA8. The discharge port is connected to the drain oil passage D which goes to hydraulic fluid tank 70. The operation lever 55 can be tilted in a front-back direction, width direction orthogonal to front and back, and an oblique direction from the neutral position. In response to the tilt of the operation lever 55, the operation valves OVA, OVB, OVC and OVD of the operation device 56 are operated. Thus, the pilot pressure corresponding to the operation amount of the operation lever 55 from the neutral position is output from the secondary ports of the operation valves OVA, OVB, OVC, and OVD. The relationship between the pilot pressure applied to the primary port outputted from the primary pressure control valve CV1 and the pilot pressure applied to the secondary port will be described later.

A secondary port of the operation valve OVA and a secondary port of the operation valve OVC are connected to an input port of a first shuttle valve SVa, and an output port of the first shuttle valve SVa is connected to a first port PLa of a left hydraulic pump 7L via a first pilot oil passage PA11. A secondary port of the operation valve OVA and a secondary port of the operation valve OVD are connected to an input port of a second shuttle valve SVb, and an output port of the second shuttle valve SVb is connected to a third port PRa of a right hydraulic pump 7R via a third pilot oil passage PA13. A secondary port of the operation valve OVB and a secondary port of the operation valve OVD are connected to an input port of a third shuttle valve SVc, and an output port of the third shuttle valve SVc is connected to a second port PLb of a left hydraulic pump 7L via a second pilot oil passage PA12. A secondary port of the operation valve OVB and a secondary port of the operation valve OVC are connected to an input port of a fourth shuttle valve SVd, and an output port of the fourth shuttle valve SVd is connected to a fourth port PRb of a right hydraulic pump 7R via a fourth pilot oil passage PA14. That is, the pilot supply oil passage PA8, the first pilot oil passage PA11 and the fourth pilot oil passage PA14 connect the pilot pump 71 and the left hydraulic pump 7L. The pilot supply oil passage PA8, the second pilot oil passage PA12, and the third pilot oil passage PA13 connect the pilot pump 71 and the right hydraulic pump 7R.

When the operation lever 55 is tilted forward, the operation valve OVA for forward operation is operated and the pilot pressure is output from the operation valve OVA. This pilot pressure acts on the first port PLa from the first shuttle valve SVa via the first pilot oil passage PA11 connecting the operation device 56 and the first port PLa of the left hydraulic pump 7L, and also acts on the third port PRa from the second shuttle valve SVb via the third pilot oil passage PA13 connecting the operation device 56 and the third port PRa of the right hydraulic pump 7R. As a result, the output shaft of the left hydraulic pump 7L and the output shaft of the right hydraulic pump 7R rotate forward (forward rotation) at a speed corresponding to the tilt amount of the operation lever 55, and the work vehicle 1 moves straight forward.

When the operation lever 55 is tilted rearward, the operation valve OVB for the backward movement is operated, and pilot pressure is output from the operation valve OVB. This pilot pressure acts on the second port PLb of the left hydraulic pump 7L via the second pilot oil passage PA12 connecting the operation device 56 and the second port applied from the third shuttle valve SVc and also acts on the fourth port PRb via the fourth pilot oil passage PA14 connecting the operation device 56 and the fourth port PRb of the right hydraulic pump 7R. As a result, the output shaft of the left hydraulic pump 7L and the output shaft of the right hydraulic pump 7R are rotated reversely (backward rotation) at a speed corresponding to the tilt amount of the operation lever 55, and the work vehicle 1 moves straight backward.

When the operation lever 55 is tilted rightward, the operation valve OVC for turning right is operated, and the pilot pressure is output from the operation valve OVC. This pilot pressure acts on the first port PLa of the left hydraulic pump 7L via the first pilot oil passage PA11 from the first shuttle valve SVa and acts on the fourth port PRb of the right hydraulic pump 7R via the fourth pilot oil passage PA14 of the fourth shuttle valve SVd. Thereby, the operation lever 55 moves curvedly to the right with the degree of bending corresponding to the operation position.

Also, when the operation lever 55 is tilted leftward, the operation valve OVD for turning to the left is operated, and the pilot pressure is output from the operation valve OVD. This pilot pressure acts on the third port PRa of the right hydraulic pump 7R from the second shuttle valve SVb via the third pilot oil passage PA13 and acts on the second port PLb of the left hydraulic pump 7L from the third shuttle valve SVc via the second pilot oil passage PA12. As a result, the operation lever 55 moves curvedly to the left with a degree of bending corresponding to the operation position.

That is, when the operation lever 55 is tilted diagonally forward and leftward, the work vehicle 1 advances at a speed corresponding to the operation position of the operation lever 55 in the front-rear direction, and bends to the left at a degree of bending corresponding to the operation position of the operation lever 55 in the left direction. When the operation lever 55 is tilted diagonally forward and rightward, the work vehicle 1 rotates to the right while the right at a speed corresponding to the operating position of the operation lever 55. When the operation lever 55 is tilted diagonally rearward and leftward, the work vehicle 1 turns to the left while moving backward at a speed corresponding to the operating position of the operation lever 55. When the operation lever 55 is tilted diagonally rearward and rightward, the work vehicle 1 rotates to the right while moving backward at a speed corresponding to the operation position of the operation lever 55.

Next, the detailed operation of the primary pressure control valve CV1 will be described. The work vehicle 1 includes a setting member 11 (see FIG. 6) for setting a target rotational speed of the engine 6. The setting member 11 is an accelerator pedal which is a speed input device different from the operation device 56 described above, a swingably supported accelerator lever, or a turnable indoor dial. The setting member 11 is provided with a sensor 12. The operation amount detected by the sensor 12 is input to the controller 10. The engine rotational speed corresponding to the operation amount detected by the sensor 12 is the target rotational speed of the engine 6. In other words, the target rotational speed of the engine 6 is set based on the operation amount of the setting member 11. The controller 10 outputs a rotation command indicating, for example, a fuel injection amount, an injection timing, and a fuel injection rate to the injector in order to become the target rotational speed of the engine 6 as determined. Alternatively, the controller 10 outputs a rotation command indicating the fuel injection pressure or the like to the supply pump or the common rail in order to become the target rotational speed of the engine 6 as determined. In the following embodiments, one or more operation levers 55 and the setting member 11 described above may be referred to as at least one operation device 56. A speed sensor 6a for detecting an actual engine rotational speed (referred to as an actual rotational speed of the engine 6) is connected to the controller 10, and the actual rotational speed of the engine 6 is input to the controller 10. The speed sensor 6a is, for example, a potentiometer configured to detect the rotational speed of a rotating member connected to the crankshaft of the engine 6. When a load is applied to the engine 6, the actual rotational speed of the engine 6 is reduced from the target rotational speed of the engine 6. Decrease amount of the actual rotational speed from the target rotational speed when a load is applied to the engine 6 from the target rotational speed (the difference between the target rotational speed of the engine 6 and the actual rotational speed of the engine 6) is referred to as a drop amount of the engine.

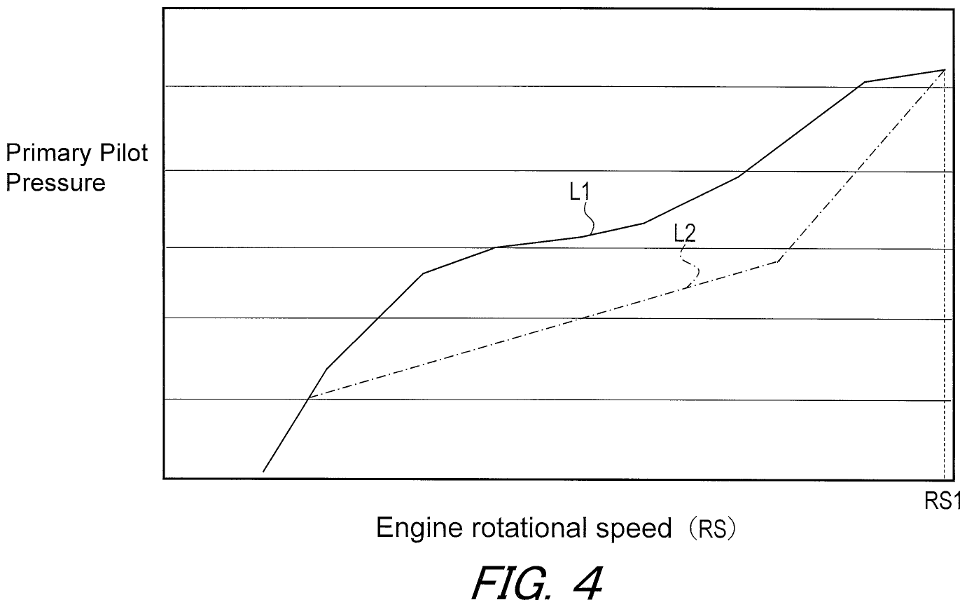

The primary pressure control valve CV1 can set pilot pressures (primary pilot pressure) acting on the input ports (primary ports) of the operation valves OVA, OVB, OVC, and OVD based on a decrease amount (drop amount) ΔE1 of the rotational speed (engine rotational speed E1) of the engine 6. In other words, the primary pressure control valve CV1 is a control valve provided between the pilot pump 71 and the operation valves OVA, OVB, OVC, and OVD and configured to supply pilot oil to the operation valves OVA, OVB, OVC, and OVD and to convert the pressure of the pilot oil supplied to the operation valves OVA, OVB, OVC, and OVD into primary pilot pressure. The rotational speed of the engine 6 can be detected by the speed sensor 6a of the engine rotational speed E1. The engine rotational speed E1 detected by the speed sensor 6a is input to the controller 10. FIG. 4 shows the relationship among the engine rotational speed, the traveling primary pressure (primary pilot pressure), and the set lines L1 and L2. The set line L1 shows the relationship between the engine rotational speed E1 when the decrease amount ΔE1 is less than a predetermined value (less than the anti-stall determination value) and the traveling primary pressure. The set line L2 shows the relationship between the engine rotational speed E1 when the decrease amount ΔE1 is equal to or greater than the anti-stall determination value and the traveling primary pressure. When the difference between the rotational speed RS determined based on the operation amount of the setting member 11 and the actual rotational speed of the engine 6 is smaller than a predetermined stall determination speed difference (anti-stall determination value), the primary pilot pressure corresponding to the rotational speed RS changes according to the third relationship indicated by the set line L1. When the difference between the rotational speed RS and the actual rotational speed of the engine 6 is equal to or greater than a predetermined stall determination speed difference (anti-stall determination value), the primary pilot pressure corresponding to the rotational speed RS changes according to the fourth relationship shown in the set line L2.

When the decrease amount ΔE1 is less than the anti-stall determination value, the controller 10 adjusts the opening of the primary pressure control valve CV1 so that the relationship between the engine rotational speed E1 and the primary pilot pressure matches the reference pilot pressure indicated by the set line L1. When the decrease amount ΔE1 is equal to or greater than the anti-stall determination value, the controller 10 adjusts the opening of the primary pressure control valve CV1 so that the relationship between the engine rotational speed E1 and the traveling primary pressure coincides with the set line L2 lower than the reference pilot pressure. At the set line L2, the primary pilot pressure for a predetermined engine rotational speed E1 is lower than the traveling primary pressure at the set line L1. That is, when attention is paid to the same engine rotational speed E1, the traveling primary pressure of the set line L2 is set lower than the traveling primary pressure of the set line L1. Therefore, by the control based on the set line L2, the pressure (pilot pressure) of the hydraulic fluid entering the operation valves OVA, OVB, OVC, and OVD is suppressed to be low. As a result, the angle of the swash plate of the left hydraulic pump 7L and the right hydraulic pump 7R is adjusted, the load acting on the engine 6 is reduced, and stalling of the engine 6 can be prevented. Although FIG. 4 shows one set line L2, a plurality of set lines L2 may be provided. For example, the set line L2 may be set for each engine rotational speed E1. Further, it is preferable that the controller 10 has data indicating the set line L1 and the set line L2, control parameters such as functions, and the like.

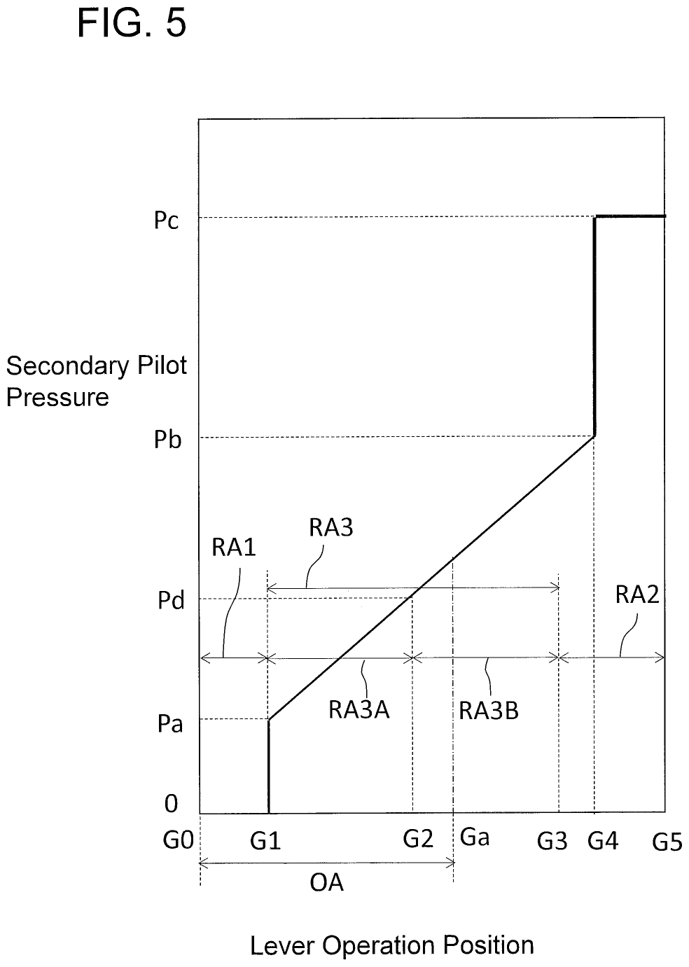

Secondly, the following describes the secondary pilot pressure output from the secondary port of the operation valves OVA, OVB, OVC, OVD. FIG. 5 is a diagram showing the relationship between the operating position of the operation lever and the secondary pilot pressure. Referring to FIG. 4, the lever operation position is an operation start position (neutral position, G0 position) in which the origin is the start position of the lever stroke, and approaches the operation end position (G5 position) in which the end position of the lever stroke is the operation end position (0 position) as the lever operation position is away from the origin. The operation area of the operation lever 55 is divided into a neutral area RA1 in which the operation target does not operate (from the G0 position to the G1 position in the drawings), a near full-operation area RA2 near the operation end (from the G3 position to the G5 position in the drawings), and an intermediate area RA3 between the neutral area RA1 and the near full-operation area RA2 (from the G1 position to the G3 position in the drawings). The intermediate area RA3 is further divided into a slow speed area RA3A extending from the G1 position to the G2 position and an intermediate speed area RA3B extending from the G2 position to the G3 position.

In the neutral area RA1, the secondary pilot pressure is not supplied even if the operation lever 55 is operated. On the other hand, in the near full-operation area RA2, the speed of the operation target is not adjusted, so that the operation lever 55 is operated to the operation end position (G5 position) without stopping in the middle. In the intermediate area RA3, the operation lever 55 is stopped at an arbitrary position within the area or the position thereof is changed so that the speed of the operation target becomes the speed desired by the operator. For example, the ratios of the operation areas RA1, RA3A, RA3B and RA2 to the lever stroke are as follows.
Neutral area RA1: 0% or more and less than 15%
Slow speed range RA3A: 15% or more and less than 45%
Intermediate speed area RA3B: 45% or more and less than 75%
Near full-operation area RA2: 75% to 100%

In the characteristic diagram shown in FIG. 5, when the operation lever 55 is operated from the G0 position to the G1 position, a secondary pilot pressure (Pa) is generated, and when the operation lever 55 is operated from the G1 position to the G4 position, the secondary pilot pressure increases from Pa to Pb in proportion to the operation amount of the operation lever 55. Then, at position G4, the primary pilot pressure is short-cut and flows to the secondary side, and the secondary pilot pressure rises from Pb to the maximum output pressure Pc at once. While the operation lever 55 is operated from the G4 position to the G5 position, the secondary pilot pressure is constant at the maximum output pressure (Pc) and becomes equal to the primary pilot pressure. That is, the operation device 56 outputs the primary pilot pressure input to the operation device 56 to the first port PLa and the fourth port PRb when the displacement of the operation lever 55 for instructing movement in the leftward direction from the neutral position is equal to or greater than the first displacement value (the displacement from G0 to G4). In the following embodiment, operating the operation lever 55 between the G4 position and the G5 position is referred to as operating the operation lever 55 in a full stroke. The operation device 56 outputs the primary pilot pressure input to the operation device 56 to the second port PLb and the third port PRa when the displacement of the operation lever 55 for instructing movement in the right direction from the neutral position is equal to or greater than a first displacement value (displacement from G0 to G4). The operation device 56 outputs the primary pilot pressure input to the operation device 56 to the first port PLa and the third port PRa when the displacement of the operation lever 55 for instructing movement in the forward direction from the neutral position is equal to or greater than a first displacement value (displacement from G0 to G4). The operation device 56 outputs the primary pilot pressure input to the operation device 56 to the second port PLb and the fourth port PRb when the displacement of the operation lever 55 for instructing movement in the backward direction from the neutral position is equal to or greater than a first displacement value (displacement from G0 to G4). The characteristic value of the longitudinal secondary pilot pressure may be different from the characteristic value of the lateral secondary pilot pressure. Assuming that the characteristic values of the longitudinal secondary pilot pressures corresponding to G0 to G5 and Pa to Pc are G0′ to G5′ and Pa′ to Pc′, the operation device 56 may output the primary pilot pressure input to the operation device 56 to the first port PLa and the third port PRa when the displacement of the operation lever 55 for instructing movement in the forward direction from the neutral position is equal to or greater than a second displacement value (displacement from G0′ to G4′). The operation device 56 may output the primary pilot pressure input to the operation device 56 to the second port PLb and the fourth port PRb when the displacement of the operation lever 55 for instructing movement in the rearward direction from the neutral position is equal to or greater than the second displacement value (the displacement from G0′ to G4′). In addition, Pa and Pb (Pa′ and Pb′) are values independent of the magnitude of the primary pilot pressure, but when the primary pilot pressure is lower than Pa or Pb (Pa′ or Pb′), the secondary pilot pressure reaches a plateau at the magnitude of the primary pilot pressure. That is, the operation valves (OVA, OVB, OVC, OVD) are configured to convert the pressure of the pilot oil from the primary pilot pressure to the secondary pilot pressure in accordance with the first operation amount (operation lever position) of the operation device 56, and output the pilot oil. The pilot oil at secondary pilot pressure is applied to ports (PLa, PRa, PLb, PRb) that provide hydraulic pressure to swash plate of hydraulic pumps (7L, 7R). When the first operation amount is equal to or greater than the threshold amount (first displacement value), the operation valves (OVA, OVB, OVC, OVD) are converted into a secondary pilot pressure equal to the primary pilot pressure.

Based on the features of the operation valves OVA, OVB, OVC and OVD described above, the movement of the work vehicle 1 corresponding to the operation of the operation lever 55 will be described in more detail. When an operation amount of the operation lever 55 in the front-rear direction is larger than an operation amount of the operation lever 55 in the right direction, and the operation position of the operation lever 55 in the right direction is operated from the G1 position to the G3 position, the work vehicle bends to the right in a large circle by rotating in the same direction in a state in which the magnitude of the rotational speed of the left hydraulic pump 7L is larger than the magnitude of the rotational speed of the right hydraulic pump 7R. When the operation position of the operation lever 55 in the right direction becomes the same position as the operation position in the front-rear direction, the rotational speed of the right hydraulic pump 7R becomes 0, and only the left hydraulic pump 7L rotates, whereby the work vehicle 1 makes a right pivotal turn (right pivot turn). In addition, when the operation position of the operation lever 55 in the right direction is operated between the G4 position and the G5 position, the output shaft of the left hydraulic pump 7L rotates in the forward direction and the output shaft of the right hydraulic pump 7R rotates in the reverse direction so that the work vehicle 1 turns rightward.

Further, when the operation amount in the front-rear direction of the operation lever 55 is larger than the operation amount in the left direction and the operation position of the operation lever 55 in the left direction is operated from the G1 position to the G3 position, the work vehicle bends to the left in a large turn by rotating in the same direction with the magnitude of the rotational speed of the right hydraulic pump 7R being larger than the magnitude of the rotational speed of the left hydraulic pump 7L. When the operation position of the operation lever 55 in the left direction becomes the same position as the operation position in the front-rear direction, the rotational speed of the left hydraulic pump 7L becomes 0, and only the right hydraulic pump 7R rotates, so that the work vehicle 1 makes a left pivotal turn (left pivot turn). Further, when the operating position of the operation lever 55 in the leftward direction is operated between the G4 position and the G5 position, the operating position becomes larger than the operating position in the front-rear direction, the output shaft of the right hydraulic pump 7R rotates in the forward direction and the output shaft of the left hydraulic pump 7L rotates in the reverse direction, so that the work vehicle turns to the left. In the present embodiment, the turning means the movement of the work vehicle 1 when the operation position to the right is operated between the G4 position and the G5 position, or when the operation position to the left is operated between the G4 position and the G5 position.

On the other hand, when the operating position in the forward direction of the operation lever 55 is operated between the G4 position and the G5 position, the operating position becomes larger than the operating position in the left-right direction, the output shafts of the left hydraulic pump 7L and the right hydraulic pump 7R rotate in the forward direction, and the work vehicle advances at high speed. When the operating position of the operation lever 55 in the backward direction is operated between the G4 position and the G5 position, the operating position becomes larger than the operating position in the left-right direction, the output shafts of the left hydraulic pump 7L and the right hydraulic pump 7R are inverted, and the work vehicle 1 moves backward at high speed. The operation of the operation lever 55 in the front-rear direction is the same as that in the left-right direction.

The work vehicle 1 includes various switches and sensors connected to the controller 10 described above. FIG. 6 is a block diagram of the work vehicle 1. Referring to FIG. 6, the work vehicle 1 includes a creep setting member 16 provided around the driver seat 54. The creep setting member 16 may be referred to as an input device. The creep setting member 16 is provided with, for example, a touch panel, a slidable slide-type switch, or a dial. Creep is to control for running the work vehicle 1 at an upper limit speed or less regardless of the operation amount of at least one operation device 56 (the setting member 11, one or a plurality of operation levers 55) to which the user's speed alteration operation is input. The upper limit speed is input by the creep setting member 16. The creep setting member 16 is configured to switch between the normal mode and the creep mode. A state in which the upper limit speed is set by the creep setting member 16 is referred to as a creep mode. The state other than the creep mode is referred to as the normal mode.

In the normal mode, the target rotational speed of the engine 6 is set by the operation of the setting member 11, and the primary pilot pressure corresponding to the target rotational speed is obtained based on the set line L1 or L2 in FIG. 4. The secondary pilot pressure is set based on the operation amount of one or a plurality of operation levers 55, and the hydraulic motors (31L, 31R) and hydraulic pumps (7L, 7R) are controlled. That is, in the normal mode, it is possible to change the speed of the work vehicle 1 in accordance with the operation amount of at least one operation device, and to run the work vehicle 1 at a speed higher than the upper limit speed. On the other hand, in the creep mode, the set line L1 or L2 in FIG. 4 is not used to determine the traveling primary pressure, but the primary pilot pressure is determined to be smaller than the primary pilot pressure in the normal mode by using first reference information 10r1 described later or the like. The setting after the secondary pilot pressure in the creep mode is the same as that in the normal mode, but since the secondary pilot pressure is equal to or less than the primary pilot pressure, the speed of the work vehicle is limited to an upper limit speed or less regardless of the operation amount of at least one operation device (setting member 11, one or a plurality of operation levers 55) by limiting the primary pilot pressure.

Referring to FIGS. 3 and 6, the work vehicle 1 includes a hydraulic pressure sensor SP11 for detecting the hydraulic pressure of a first pilot oil passage PA11, a hydraulic pressure sensor SP12 for detecting the hydraulic pressure of a second pilot oil passage PA12, an hydraulic pressure sensor SP13 for detecting the hydraulic pressure of a third pilot oil passage PA13, and a hydraulic pressure sensor SP14 for detecting the hydraulic pressure of a fourth pilot oil passage PA14. As described above, the secondary pilot pressure output from the secondary ports of the operation valves OVA, OVB, OVC, and OVD changes in accordance with the operation position of the operation lever 55. Therefore, the hydraulic pressure sensors SP11 to SP14 are sensors for detecting the secondary pilot pressure. The hydraulic pressure sensors SP11 to SP14 may be referred to as an additional hydraulic pressure sensor.

A work vehicle 1 includes a hydraulic pressure sensor SP5L for detecting the hydraulic pressure of a drive oil passage PA5L, a hydraulic pressure sensor SP6L for detecting the hydraulic pressure in the drive oil passage PA6L, a hydraulic pressure sensor SP5R for detecting the hydraulic pressure in the drive oil passage PA5R, and a hydraulic pressure sensor SP6R for detecting the hydraulic pressure in the drive oil passage PA6R. That is, the hydraulic pressure sensors SP5L, SP6L, SP5R, SP6R are configured to detect the hydraulic pressure of the hydraulic fluid in the drive oil passages PA5L, PA6L, PA5R, PA6R. The states of the left hydraulic motor 31L and the right hydraulic motor 31R can be detected from the pressure difference between the hydraulic sensor SP5L and the hydraulic sensor SP6L and the pressure difference between the hydraulic sensor SP5R and the hydraulic sensor SP6R.

Referring to FIGS. 2, 3, and 6, the work vehicle 1 includes a rotation sensor SR31L for detecting the rotational speed of the left hydraulic motor 31L and a rotation sensor SR31R for detecting the rotational speed of the right hydraulic motor 31R, which are connected to the rotational shaft of the left hydraulic motor 31L. The states of the left hydraulic motor 31L and the right hydraulic motor 31R can be detected from the magnitude of the rotational direction and rotational speed detected from the rotational sensor SR31L and the magnitude of the rotational direction and rotational speed detected from the rotational sensor SR31R. The work vehicle 1 may include an operation detection sensor 18 for detecting the operation position of the operation lever 55. The operation detection sensor 18 is connected to a controller 10 to be described later. The operation detection sensor 18 is a position sensor for detecting the position of the operation lever 55.

### <Configuration of Controller 10>

The controller 10 includes a processor 10a and a memory 10b as shown in FIG. 6 in order to realize the control of the vehicle speed in the creep mode described above. The processor 10a may be referred to as an electronic circuit (circuitry). The memory 10b includes a volatile memory and a non-volatile memory. The memory 10b includes at least a travel control program 10c1 for realizing the above-described control, first reference information 10r1, second reference information 10r2, third reference information 10r3.

The first reference information 10r1 represents a first correspondence relationship between the rotational speed RS of the engine 6 detected by the speed sensor 6a and the primary pilot pressure in the normal mode. That is, the first reference information 10r1 represents the first correspondence relationship represented by the set line L1 in FIG. 4. The second reference information 10r2 represents a second correspondence relationship between the rotational speed RS of the engine 6 detected by the speed sensor 6a and the primary pilot pressure, which is used to control the primary pilot pressure when the drop amount of the engine 6 is large in the normal mode. That is, the second reference information 10r2 represents the second correspondence relationship represented by the set line L2 in FIG. 4.

The third reference information 10r3 represents a third correspondence relationship between the upper limit speed in the mode, the absolute value of the first differential pressure, and the pressure output from the primary pressure control valve for determining the primary pilot pressure of the pilot oil input to the operation valves OVA, OVB, OVC, and OVD, which corresponds to the upper limit speed and the absolute value of the first differential pressure. The first differential pressure is a differential pressure having a larger absolute value among a differential pressure between the hydraulic pressure sensor SP5L and the hydraulic pressure sensor SP6L and a differential pressure between the hydraulic pressure sensor SP5R and the hydraulic pressure sensor SP6R. The third correspondence relationship does not depend on the rotational speed of the engine 6 of the work vehicle 1.

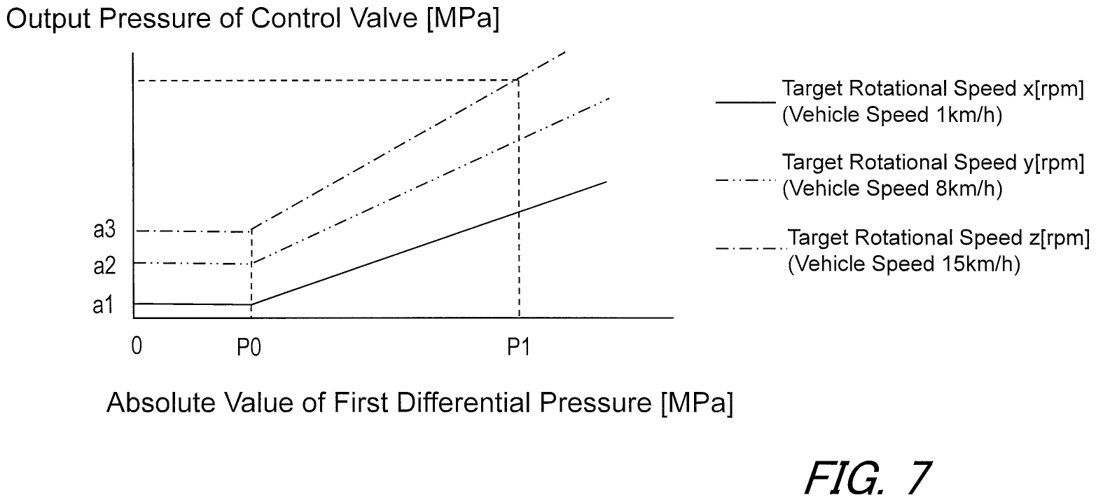

FIG. 7 shows an example of the first reference information 10r1. FIG. 7 shows the absolute value of the first differential pressure as the horizontal axis and the pressure (output pressure) output from the primary pressure control valve CV1 as the vertical axis in order to clearly explain the third correspondence relationship. This output pressure corresponds to the primary pilot pressure to be controlled. Although FIG. 7 shows the relationship between the absolute value of the first differential pressure and the output pressure in the case of the target rotational speeds x [rpm], y [rpm], and z [rpm] of the hydraulic motor corresponding to the upper limit speeds of 1 km/h, 8 km/h, and 15 km/h by a line graph, the third correspondence relationship may include the relationship between the absolute value of the first differential pressure and the output pressure at other target rotational speeds of the motor. Here, when the first differential pressure is up to P0, the setting member 11 (for example, an accelerator pedal) is operated so as to become equal to or higher than a predetermined target rotational speed, the secondary pilot pressure becomes equal to the primary pilot pressure, and when the traveling devices 3 are unloaded, the output pressure determined so as to reach the upper limit speed of the mode is stored as first reference information 10r1. When the first differential pressure is larger than P0, the output pressure increases as the target rotational speed increases. Specifically, the output pressure changes linearly with respect to the absolute value of the first differential pressure so that the inclination becomes larger as the target rotational speed (upper limit speed) becomes larger. Although the example of FIG. 7 is a linear function change, other changes may be used as long as the change is a monotonic increase. A range below the lower limit of the upper limit speed designated in FIG. 7 and a range above the upper limit speed is a speed range that cannot be set by the creep setting member 16. In FIG. 7, 1 km/h designated as the lower limit and 15 km/h designated as the upper limit are examples, and other values may be set. An output pressure corresponding to a plurality of speeds may be set between the upper limit and the lower limit. The output pressure corresponding to the non-set upper limit speed may be estimated by linear interpolation or the like. When the upper limit speed set by the creep setting member 16 is out of the range represented by the third correspondence relationship, the speed control in the normal mode is performed. Further, since the third correspondence relation is equal to or less than the primary pilot pressure shown by the set line L2 in FIG. 4, it also has an anti-stall effect.

The processor 10a executes the following control while executing the travel control program 10c1 while referring to the first reference information 10r1, the second reference information 10r2, and the third reference information 10r3. First, when the normal mode is selected by the creep setting member 16, the processor 10a acquires the rotational speed RS of the engine 6 from the speed sensor 6a, finds a primary pilot pressure corresponding to the detected rotational speed RS of the engine 6 from the first reference information 10r1, and controls the primary pressure control valve CV1 so that the primary pilot pressure is obtained. When the normal mode is selected and the drop amount of the engine 6 is large, the processor 10a determines a primary pilot pressure corresponding to the rotational speed RS of the engine 6 detected by the speed sensor 6a from the second reference information 10r2, and controls the primary pressure control valve CV1 so that the primary pilot pressure becomes the determined primary pilot pressure.

When a mode is selected by a creep setting member 16, a processor 10a determines a target rotational speed by acquiring an upper limit speed inputted by the creep setting member 16, determines the absolute value of a first differential pressure from information obtained from hydraulic pressure sensors SP5L, SP6L, SP5R, SP6R, extracts information for determining a primary pilot pressure from third reference information 10r3, and determines a primary pilot pressure based on the extracted information. Then, the processor 10a controls the primary pressure control valve CV1 so that the obtained primary pilot pressure becomes as determined. When the primary pilot pressure is controlled, the upper limit of the ports PLa, PRa, PLb, PRb that provide hydraulic pressure to the swash plates of the hydraulic pumps 7L, 7R is controlled.

In the following embodiments, a hydraulic motor having a larger differential pressure among the hydraulic motors 31L, 31R is referred to as a first hydraulic motor. Among the left traveling device 3L and the right traveling device 3R, a traveling device driven by a first hydraulic motor is referred to as a first traveling device. Among the first swash plate switching cylinder 32L and the second swash plate switching cylinder 32R, a cylinder provided in the first hydraulic motor is referred to as a first motor pilot port. The pilot pressure applied to the first motor pilot port is referred to as a first motor pilot pressure. Among the hydraulic pumps 7L, 7R, a hydraulic pump for supplying hydraulic fluid to the first hydraulic motor is referred to as a first hydraulic pump. Among the ports PLa, PRa, PLb, PRb of the first hydraulic pump, a port to which the pilot pressure input by the primary pilot pressure is limited is referred to as a first pump pilot port. The pilot pressure applied to the first pump pilot port is referred to as a first pump pilot pressure. Among drive oil passages PA5L, PA6L, PA5R, PA6R for connecting the first hydraulic motor and the first hydraulic pump, one oil passage is referred to as a first oil passage, and the other oil passage is referred to as a second oil passage. The pilot pressure of the first oil passage is referred to as a first hydraulic pressure, and the pilot pressure of the second oil passage is referred to as a second hydraulic pressure. Among the hydraulic pressure sensors SP5L, SP6L, SP5R, SP6R, a hydraulic pressure sensor configured to detect a first hydraulic pressure is referred to as a first hydraulic pressure sensor, and a hydraulic pressure sensor configured to detect a second hydraulic pressure is referred to as a second hydraulic pressure sensor. Among the rotational speed sensors SR31L, SR31R, a rotational speed sensor configured to detect the rotational speed of the first hydraulic motor is referred to as a first rotational speed sensor. Among the first to fourth pilot oil passages PA11 to PA14, an oil passage connecting the operation valves OVA, OVB, OVC, and OVD and the first pump pilot port is referred to as a secondary pilot oil passage.

Among the left traveling device 3L and the right traveling device 3R, a traveling device provided on the side opposite to the first hydraulic motor of the vehicle body 2 is referred to as a second traveling device. Among the hydraulic motors 31L, 31R, a hydraulic motor configured to drive the second traveling device is referred to as a second hydraulic motor. Among the first swash plate switching cylinder 32L and the second swash plate switching cylinder 32R, a cylinder provided in the second hydraulic motor is called a second motor pilot port. The pilot pressure applied to the second motor pilot port is referred to as a second motor pilot pressure. Among hydraulic pumps 7L, 7R, a hydraulic pump for supplying hydraulic fluid to a second hydraulic motor is referred to as a second hydraulic pump. Among the ports PLa, PRa, PLb, PRb of the second hydraulic pump, a port to which the pilot pressure input by the primary pilot pressure is limited is referred to as a second pump pilot port. The pilot pressure applied to the second pump pilot port is referred to as a second pump pilot pressure. Among two oil passages connecting the second hydraulic motor and the second hydraulic pump among the drive oil passages PA5L, PA6L, PA5R, PA6R, one oil passage is referred to as a third oil passage, and the other oil passage is referred to as a fourth oil passage. The pilot pressure of the third oil passage is referred to as a third hydraulic pressure, and the pilot pressure of the fourth oil passage is referred to as a fourth hydraulic pressure. Among hydraulic pressure sensors SP5L, SP6L, SP5R, SP6R, a hydraulic pressure sensor configured to detect a third hydraulic pressure is referred to as a third hydraulic pressure sensor, and a hydraulic pressure sensor configured to detect a fourth hydraulic pressure is referred to as a fourth hydraulic pressure sensor. Among the rotational speed sensors SR31L, SR31R, a rotational speed sensor configured to detect the rotational speed of the second hydraulic motor is referred to as a second rotational speed sensor. Among the first to fourth pilot oil passages PA11 to PA14, an oil passage connecting the operation valves OVA, OVB, OVC, and OVD and the second pump pilot port is referred to as an additional secondary pilot oil passage.

In the first embodiment, when a target rotational speed of an engine 6 set by a setting member 11 is a rotational speed capable of achieving an upper limit speed set by a creep setting member 16 and operation lever 55 is operated in a full stroke, a controller 10 determines the absolute value of a first differential pressure which is the difference between a first hydraulic pressure and a second hydraulic pressure, and controls the first pump pilot pressure and the second pump pilot pressure according to the absolute value of the first differential pressure such that a predetermined target speed of a vehicle is controlled to be maintained (upper limit speed). Specifically, when the target rotational speed of the engine 6 set by the setting member 11 is a rotational speed capable of achieving the upper limit speed set by the creep setting member 16 and when the operation lever 55 is operated in the full stroke, the controller 10 controls the primary pressure control valve CV1 so as to control the primary pilot pressure so as to maintain the vehicle speed at the target speed. As shown in the correspondence relationship of FIG. 7, the controller 10 controls so that the output pressure outputted from the primary pressure control valve CV1, that is, the primary pilot pressure increases as the absolute value of the first differential pressure increases.

### Operation of Work Vehicle According to First Embodiment

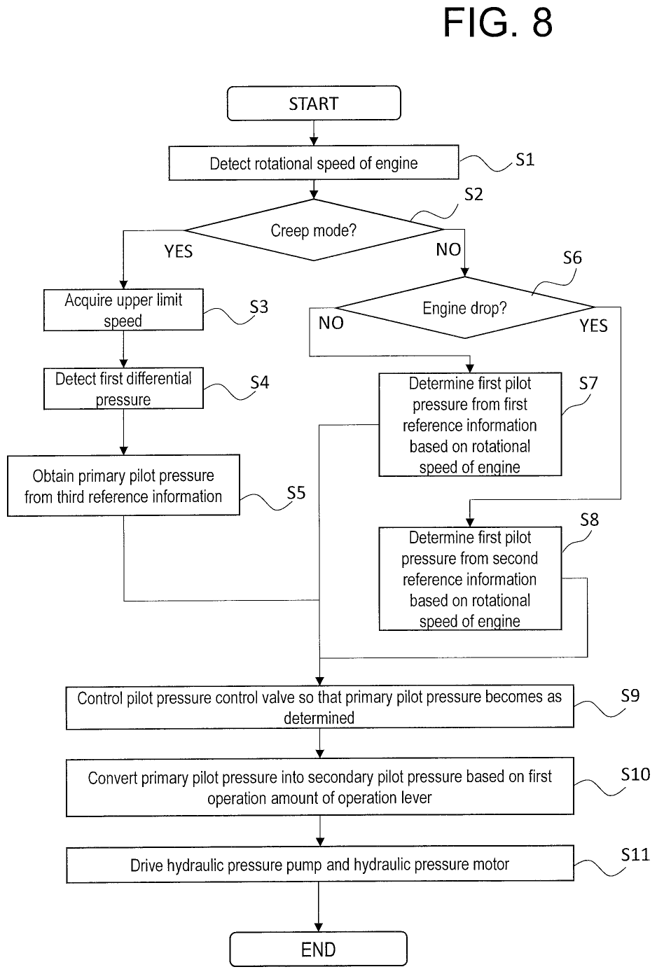

FIG. 8 is a flowchart showing the operation of the work vehicle 1 according to the first embodiment. In this flowchart, the processes from step S1 to step S11 are executed at predetermined sampling intervals (e.g., 20 μs). In step S1, the processor 10a rotates the engine 6 and sends the hydraulic fluid from the first hydraulic pump to the first hydraulic motor for driving the first traveling device provided in the vehicle body 2. Then, the processor 10a acquires the rotational speed RS of the engine 6 detected by the speed sensor 6a. That is, the method for controlling the work vehicle 1 according to the present embodiment includes acquiring the rotational speed RS of the engine 6 detected by the speed sensor 6a. In step S2, the processor 10a determines whether or not the mode has been selected by the creep setting member 16. That is, the control method according to the present embodiment includes determining whether or not the creep mode has been selected by the creep setting member 16. When the creep mode is set, that is, when the upper limit speed is set (Yes in step S2), the process proceeds from step S3 to step S5. When the normal mode is set, that is, when no upper limit speed is set, or when an invalid upper limit speed having no first correspondence relation or second correspondence relation is set (No in step S2), the process proceeds from step S6 to step S8.

In the creep mode (Yes in step S2), in step S3, the processor 10a acquires the upper limit speed input by the creep setting member 16, that is, the target rotational speed of the first hydraulic motor. In other words, the control method according to the present embodiment acquires the upper limit speed input by the creep setting member 16, that is, the target rotational speed of the first hydraulic motor. In step S3, the processor 10a acquires the hydraulic pressures detected by the hydraulic pressure sensor SP5L, the hydraulic pressure sensor SP6L, the hydraulic pressure sensor SP5R, and the hydraulic pressure detected by the hydraulic pressure sensor SP6R, and determines the first differential pressure from these. In other words, the control method according to the present embodiment detects the first differential pressure which is the larger one of the differential pressures of the hydraulic motors (31L, 31R) for running the work vehicle 1. The hydraulic motor for running the work vehicle 1 (31L, 31R), a second differential pressure which is the smaller of the two differential pressures, is detected.

In step S5, the processor 10a, referring to the third reference information 10r3, obtains the output pressure outputted from the primary pressure control valve CV1 corresponding to the target rotational speed and the absolute value of the first differential pressure, that is, the primary pilot pressure. After process of the step S5 is completed, the process of step S9 is executed. In step S9, the processor 10a controls the primary pressure control valve CV1 for sending the pilot oil to the operation valves OVA, OVB, OVC, and OVD so that the primary pilot pressure becomes as determined in step S6. That is, when the target rotational speed of the engine 6 set by the setting member 11 is a rotational speed capable of achieving the upper limit speed set by the creep setting member 16 and the operation lever 55 is operated in the full stroke, the processor 10a controls the first pump pilot port and a second pump pilot port according to the absolute value of the first differential pressure in order to control a vehicle speed to maintain a predetermined target speed. Controlling the first pump pilot pressure and the second pump pilot port includes controlling the pilot pump for discharging pilot oil toward the first pump pilot port and the second pump pilot port, and the primary pilot pressure which is the hydraulic pressure of a primary pilot oil passage that connects an operation valve that is controlled according to an input to a travel instruction input device into which an instruction of a traveling direction input by a user. Specifically, the processor 10a controls the first pump pilot pressure and the second pump pilot port to increase as the absolute value of the first differential pressure increases.

In the normal mode (No in step S2), in step S6, the processor 10a determines whether or not there is an engine drop. That is, in step S6, the processor 10a determines whether or not the decrease amount ΔE1 of the engine 6 is equal to or greater than the anti-stall determination value. When there is no engine drop (No in step S6), in step S7, the processor 10a obtains the primary pilot pressure from the first reference information 10r1 based on the rotational speed RS of the engine 6. When there is engine drop (Yes in step S6), in step S8, the processor 10a obtains the primary pilot pressure from the second reference information 10r2 based on the rotational speed RS of the engine 6. After completion of the processing of step S7 or step S8, the processing of step S9 is executed.

In step S9, the processor 10a controls the primary pressure control valve CV1 which sends the pilot oil to the operation valves OVA, OVB, OVC, and OVD so that the primary pilot pressure becomes determined in step S8 or step S9. In step S10, the operation valves OVA, OVB, OVC, and OVD convert the primary pilot pressure into the secondary pilot pressure based on the lever position (first operation amount) of the operation lever 55 (first operation device). For the pilot oil in step S11, the secondary pilot pressure of the pilot oil is applied to the ports (PLa, PRa, PLb, PRb) that provide hydraulic pressure to the swash plate of hydraulic pumps (7L, 7R) and the hydraulic pumps (7L, 7R) and the hydraulic motors (31L, 31R) are controlled.

### Operation and Effect of First Embodiment

In a method for controlling a work vehicle 1 or a work vehicle 1 according to a first embodiment, a processor 10a acquires an upper limit speed target rotational speed of a first motor inputted by a creep setting member 16, acquires an absolute value of a first differential pressure, determines an output pressure (primary pilot pressure) outputted from the primary pressure control valve CV1 corresponding to the acquired target rotational speed and the absolute value of the first differential pressure from third reference information 10r3, and controls the primary pressure control valve CV1 for sending pilot oil to operation valves OVA, OVB, OVC, OVD so that the primary pilot pressure becomes the determined primary pilot pressure. By controlling the primary pilot pressure by utilizing the variation of the first differential pressure, it is possible to realize an improvement in the user's feeling of use in the creep mode.

### Second Embodiment

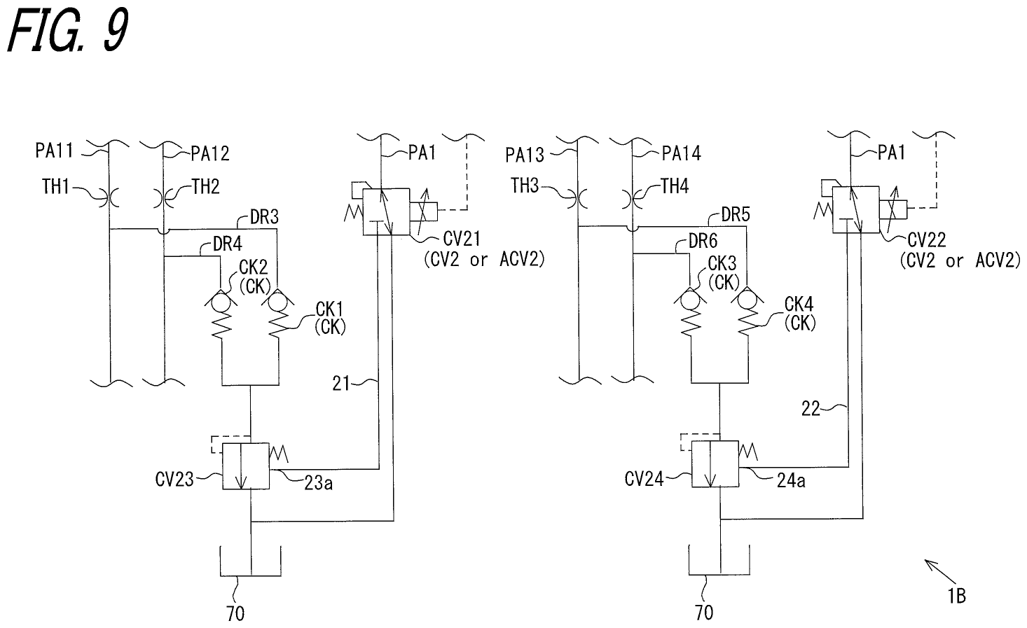

In the first embodiment, the primary pilot pressure is controlled in order to realize the creep mode, but the secondary pilot pressure may be controlled. FIG. 9 is a hydraulic circuit diagram of a travel system of the work vehicle 1 according to the second embodiment. FIG. 9 shows a configuration added to FIG. 3. In FIG. 9, the same components as those in FIG. 3 are denoted by the same reference numerals, and detailed description thereof is omitted. In the second embodiment, the work vehicle 1 includes a hydraulic circuit 1B. The hydraulic circuit 1B of the hydraulic circuit 1A, the hydraulic circuit 1B includes relief valves CV23 and CV24, proportional valves CV21 and CV22, discharge oil passages DR3 to DR6, check valves CK1 to CK4 and throttles TH1 to TH4.

The relief valves CV23 and CV24 are balanced relief valves whose set pressure to be opened based on the pressure of pilot oil is variable, and have control ports 23a and 24a for receiving the pressure of pilot oil. The relief valves CV23 and CV24 are configured to open when the pressure associated with the input port is greater than the pressure applied to the control ports 23a and 24a. At this time, the pilot oil is discharged into the hydraulic fluid tank 70. The proportional valves CV21 and CV22 are connected hydraulic fluid passages 23 and 24a which are connected to the control ports 23a, 24a proportional valves CV21 and CV22, and pilot oil is supplied from a pilot pump 71. The proportional valves CV21 and CV22 are electromagnetic proportional valves whose opening degree can be changed by exciting a solenoid, and are controlled by a controller 10.

The proportional valves CV21 and CV22 are connected to the pilot supply oil passage PA1 and control the secondary pressure control valve CV2 so as to obtain a pressure obtained by adding an offset a in consideration of the outflow of pilot oil from the relief valves CV23, CV24, etc. to the primary pressure control valve CV1 in the first embodiment in the creep mode, and operate the secondary pressure control valve CV2 when anti-stall control is not performed in the normal mode in order to obtain a value by adding an offset a to the set line L1. Among the proportional valves CV21 and CV22, the proportional valve for controlling the hydraulic pressure of the pilot oil in the secondary pilot oil passage may be referred to as a secondary pressure control valve CV2, and the proportional valve for controlling the pilot oil in the additional secondary pilot oil passage may be referred to as an additional secondary pressure control valve ACV2. That is, the secondary pressure control valve CV2 controls the secondary pilot pressure, which is the hydraulic pressure of the pilot oil in the secondary pilot oil passage. The additional secondary pressure control valve ACV2 controls an additional secondary pilot pressure which is the hydraulic pressure of the pilot oil in the additional secondary pilot oil passage. When a target rotational speed of an engine 6 set by a setting member 11 is a rotational speed capable of achieving an upper limit speed set by a creep setting member 16 and operation lever 55 is operated in a full stroke, a controller 10 controls a first pump pilot pressure corresponding to a secondary pilot pressure by controlling a secondary pressure control valve CV2, and controls the vehicle speed so as to maintain a target speed. That is, when the target rotational speed of the engine 6 set by the setting member 11 is a rotational speed capable of achieving the upper limit speed set by the creep setting member 16 and the operation lever 55 is operated in the full stroke, the controller 10 determines the absolute value of a first differential pressure which is the difference between a first hydraulic pressure and a second hydraulic pressure, and controls the first pump pilot pressure in accordance with the absolute value of the first differential pressure in order to control the vehicle speed to maintain the predetermined target speed (upper limit speed). The controller 10 controls so that the output pressure outputted from the secondary pressure control valve CV2, i.e., the secondary pilot pressure increases as the absolute value of the first differential pressure increases. When the target rotational speed of an engine 6 set by a setting member 11 is a rotational speed capable of achieving an upper limit speed set by a creep setting member 16 and operation lever 55 is operated in a full stroke, a controller 10 obtains the absolute value of a second differential pressure which is the difference between a third hydraulic pressure and a fourth hydraulic pressure, and when the absolute value of the first differential pressure is larger than the absolute value of the second differential pressure, the controller 10 controls the second pump pilot pressure according to the absolute value of the first differential pressure in order to control a vehicle speed to maintain a predetermined target speed. Specifically, the controller 10 controls the second pump pilot pressure to increase as the absolute value of the first differential pressure increases.

The discharge oil passage DR3 is connected to the first pilot oil passage PA11. The discharge oil passage DR4 is connected to the second pilot oil passage PA12. The discharge oil passage DR5 is connected to the third pilot oil passage PA13. The discharge oil passage DR6 is connected to the fourth pilot oil passage PA14. The check valves CK1 to CK4 shut off the discharge oil passages DR3 to DR6 when the pressure on the side of the throttles TH1 to TH4 does not become higher than the pressure on the side of the relief valves CV23 and CV24.

Since the pilot pressures of the discharge oil passage DR3 and the discharge oil passage DR4 increase when the left hydraulic pump 7L rotates forward and backward, respectively, when the pilot pressure of either one side becomes equal to the primary pilot pressure, the other side becomes significantly smaller than the primary pilot pressure. Since the pilot pressures of the discharge oil passage DR5 and the discharge oil passage DR6 increase when the right hydraulic pump 7R rotates in the forward direction and in the reverse direction, respectively, when the pilot pressure of either one side becomes equal to the primary pilot pressure, the other side becomes significantly smaller than the primary pilot pressure. When the proportional valves CV21 and CV22 are controlled as shown in FIG. 7, only one of the check valves CK1 and CK2 is opened, and only one of the check valves CK1 and CK2 is opened. Therefore, the above-described control can be executed by controlling the pressures of the proportional valves CV21 and CV22 so that the proportional valves CV21 and CV22 have a pressure obtained by adding a pressure loss caused by the outflow of pilot oil from the relief valves CV23 and CV24 to the pressure controlled by the primary pressure control valve CV1 according to the first embodiment.

The throttle TH1 is provided in the first pilot oil passage between the first shuttle valve SVa and the discharge oil passage DR3, configured to decrease flow rate of pilot oil in the first pilot oil passage. The throttle TH2 is provided in the second pilot oil passage PA12 between the second shuttle valve SVb and the discharge oil passage DR4, and is configured to reduce the flow rate of the pilot oil in the second pilot oil passage PA12. The throttle TH3 is provided in the third pilot oil passage PA13 between the third shuttle valve SVc and the discharge oil passage DR5, and is configured to reduce the flow rate of the pilot oil in the third pilot oil passage PA13. The throttle TH4 is provided in the fourth pilot oil passage PA14 between the fourth shuttle valve SVd and the discharge oil passage DR6, and is configured to reduce the flow rate of the pilot oil in the fourth pilot oil passage PA14.

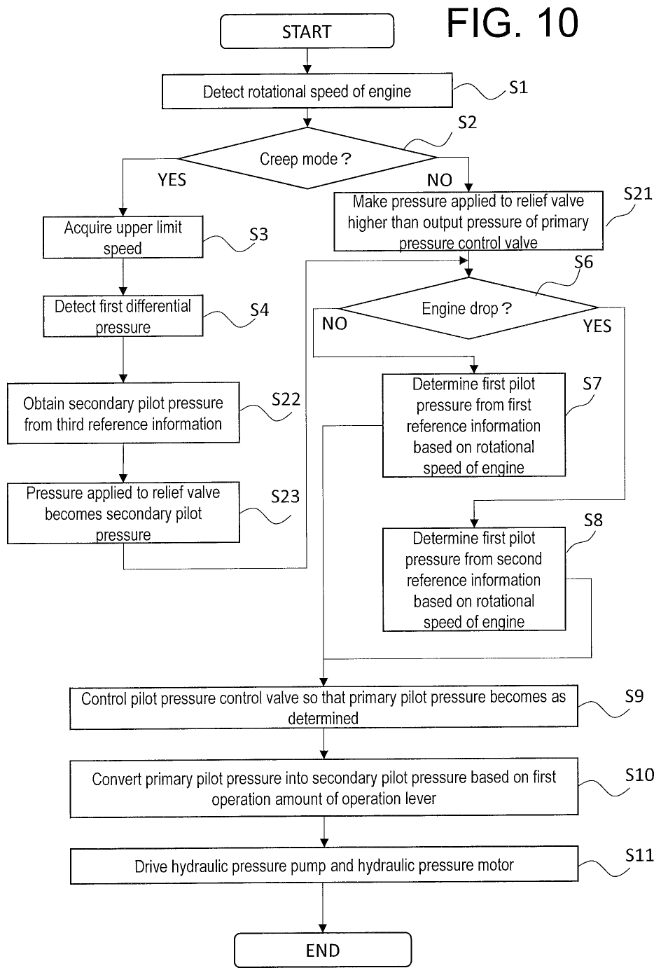

FIG. 10 is a flowchart showing the operation of the work vehicle 1 according to the second embodiment. In this flowchart, the processes from step S1 to step S11 are executed at predetermined sampling intervals (e.g., 20 μs). In FIG. 10, the same processes as those in FIG. 8 are denoted by the same step numbers, and description thereof is omitted. In the normal mode (Yes in step S2), the processor 10a controls the proportional valves CV21 and CV22 so that the pressure applied to the relief valves CV23 and CV24 is higher than the pressure output from the primary pressure control valve CV1 as described above. This allows you to close relief valves CV23, CV24.

In the creep mode (Yes in step S2), after step S4, in step S22, the processor 10a refers to the third reference information 10r3 to obtain output pressures outputted from the secondary pressure control valve CV2 and the additional secondary pressure control valve ACV2 (proportional valves CV21 and CV22) corresponding to the target rotational speed and the absolute value of the first differential pressure, that is, the secondary pilot pressure. In step 23, the processor 10a controls the secondary pressure control valve CV2 and the additional secondary pressure control valve ACV2 (proportional valves CV21 and CV22) such that the pressure applied to the relief valves CV23 and CV24 becomes equal to the secondary pilot pressure+the differential pressure between the check valves CK1 to CK4. That is, when the target rotational speed of the engine 6 set by the setting member 11 is a rotational speed capable of achieving the upper limit speed set by the creep setting member 16 and the operation lever 55 is operated in the full stroke, the processor 10a controls the first pump pilot pressure applied to the first pump pilot port of the first hydraulic pump in order to control a vehicle speed to maintain a predetermined target speed according to the absolute value of the first differential pressure. Controlling the first pump pilot pressure includes controlling the secondary pilot pressure which is the hydraulic pressure of the secondary pilot oil passage connecting the operation valve and the first pump pilot port. Specifically, the processor 10a controls the first pump pilot pressure to increase as the absolute value of the first differential pressure increases.

When the target rotational speed of an engine 6 set by a setting member 11 is a rotational speed capable of achieving an upper limit speed set by a creep setting member 16 and when operation lever 55 is operated in a full stroke, a processor 10a controls a second pump pilot pressure applied to a second pump pilot port of a second hydraulic pump according to the absolute value of a first differential pressure when the absolute value of the first differential pressure is greater than the absolute value of the second differential pressure in order to control a vehicle speed to maintain a predetermined target speed. Controlling the second pump pilot pressure includes controlling the additional secondary pilot pressure which is the hydraulic pressure of the additional secondary pilot oil passage connecting the operation valve and the second pump pilot port. Specifically, the processor 10a controls the second pump pilot pressure to increase as the absolute value of the first differential pressure increases. After step S23, the process proceeds to step S6.

### Operation and Effect of Second Embodiment

In a method for controlling a work vehicle 1 or a work vehicle 1 according to a second embodiment, a processor 10a acquires an upper limit speed (target rotational speed of a first motor) inputted by a creep setting member 16, acquires an absolute value of a first differential pressure), calculates an output pressure (secondary pilot pressure) outputted from a secondary pressure control valve CV2 and an additional secondary pressure control valve ACV2 (proportional valves CV21, CV22) corresponding to the acquired target rotational speed and the absolute value of the first differential pressure from third reference information 10r3, and controls the secondary pressure control valve CV2, additional secondary pressure control valve ACV2, (proportional valves CV21 and CV22) to become the calculated secondary pilot pressure. By controlling the secondary pilot pressure using the variation of the first differential pressure, it is possible to realize an improvement in the user's feeling of use in the creep mode.

### Modified Example of Second Embodiment

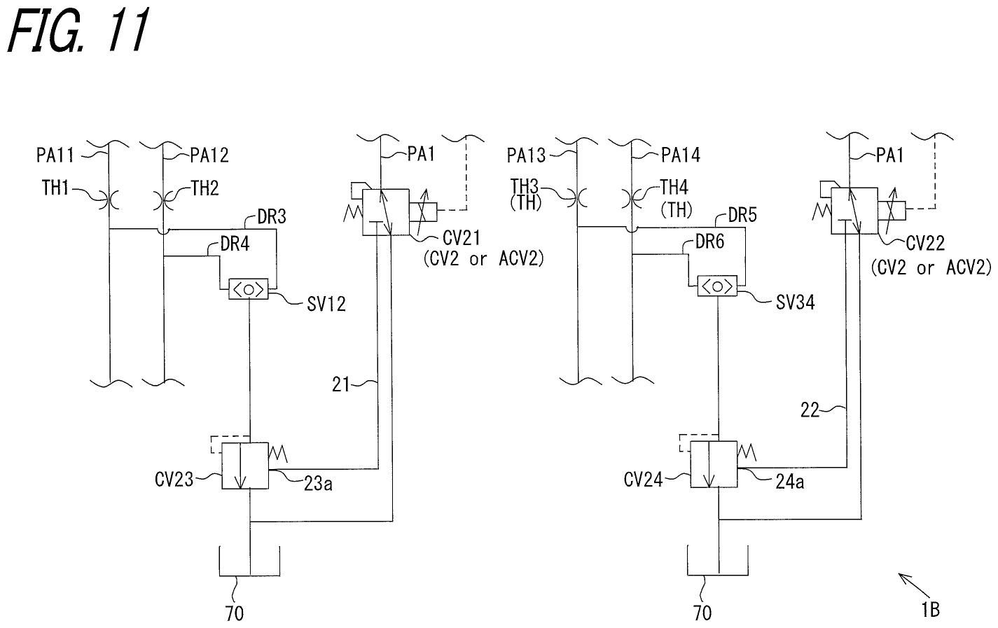

FIG. 11 is a hydraulic circuit diagram according to a modification of the second embodiment. In the example of FIG. 11, shuttle valves SV12 and SV34 are provided in place of check valves CK1 to CK4 of the example of FIG. 9. The shuttle valve SV12 connects an oil passage having a high hydraulic pressure among the discharge oil passage DR3 and the discharge oil passage DR4 to the relief valve CV23. The shuttle valve SV34 connects an oil passage having a high hydraulic pressure among the discharge oil passage DR5 and the discharge oil passage DR6 to the relief valve CV24. Even with this configuration of the hydraulic circuit, the above-described control can be executed. Further, in the circuit of FIG. 9 or 11, the primary pressure control valve CV1 may be omitted. Further, at least one of a combination of the secondary pressure control valve CV2 and the balanced relief valve and a combination of the additional secondary pressure control valve ACV2 and the balanced relief valve may be realized by an electromagnetic proportional relief valve.

In the second embodiment, when the absolute value of the first differential pressure is larger than the absolute value of the second differential pressure, the processor 10a controls the second pump pilot pressure applied to the second pump pilot port of the second hydraulic pump according to the absolute value of the first differential pressure. However, when the difference between the absolute value of the first differential pressure and the absolute value of the second differential pressure is within a predetermined range, the processor 10a may control the second pump pilot pressure applied to the second pump pilot port of the second hydraulic pump according to the absolute value of the second differential pressure. In this case, the absolute value of the first differential pressure in FIG. 7 is replaced with the absolute value of the second differential pressure, and the processor 10a may control so that the output pressure on the vertical axis is output from the additional secondary pressure control valve ACV2. Thus, when the absolute value of the first differential pressure is not significantly different from the absolute value of the second differential pressure, the left and right traveling devices are separately controlled so that an operation such as turning close to the user's desire can be realized.

### Third Embodiment

In the first embodiment and the second embodiment, the controller 10 controls the first pump pilot pressure and the second pump pilot pressure in accordance with the absolute value of the first differential pressure. In the third embodiment, the controller 10 acquires the target rotational speed set by the setting member 11, the first differential pressure, and the above-described upper limit speed in the creep mode. The controller 10 calculates a speed increase amount to be increased from the target rotational speed based on the first differential pressure and the upper limit speed in the creep mode. The controller 10 outputs a rotation command based on the corrected target rotational speed obtained by adding the calculated rotational speed increase amount to the target rotational speed. In the third embodiment, the memory 10b further includes fourth reference information 10r4 representing a fourth correspondence relationship between the absolute values of the target rotational speed and the first differential pressure of the first hydraulic motor corresponding to the upper limit speed in the creep mode and the rotational speed increase amount. When the work vehicle 1 of the third embodiment has the hydraulic circuit 1A of the first embodiment, the controller 10 limits the output pressure outputted from the primary pressure control valve CV1 in order to realize the upper limit speed in the creep mode. When the work vehicle 1 according to the third embodiment has the hydraulic circuit 1B according to the second embodiment, the controller 10 controls output pressure output from the secondary pressure control valve CV2 and the additional secondary pressure control valve ACV2 according to the second embodiment.

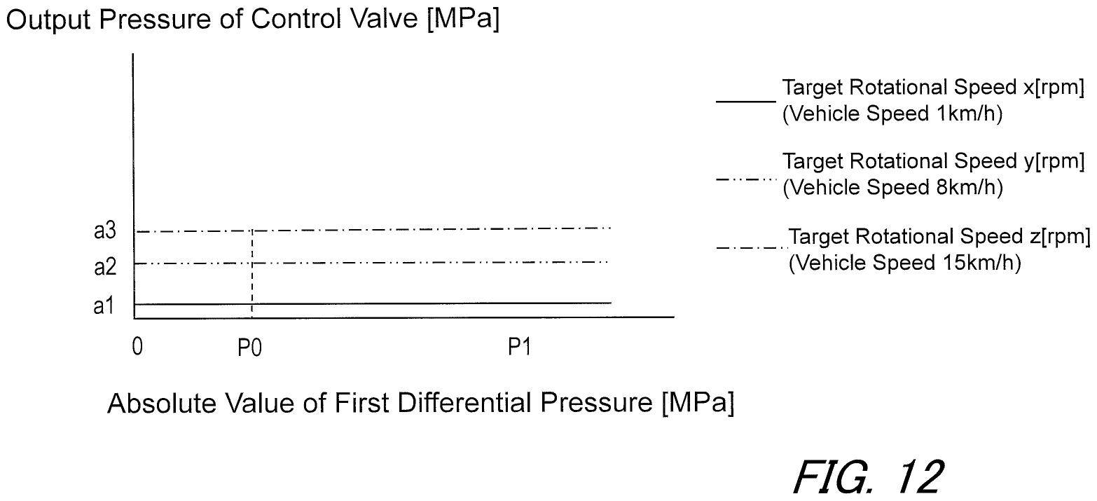

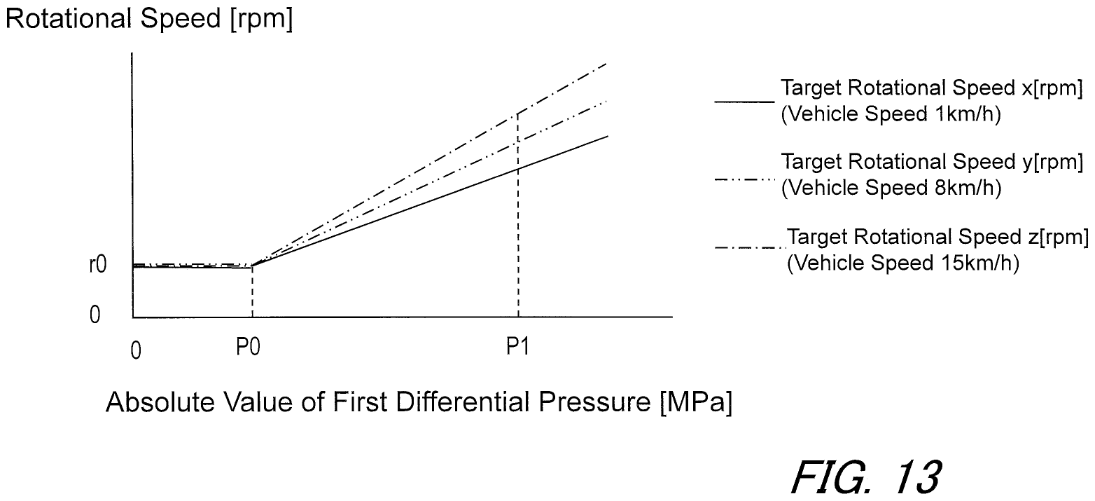

FIG. 12 shows an example of the third reference information 10r3 according to the third embodiment. As shown in FIG. 12, in the third embodiment, the output pressure output from the control valve is constant without changing the magnitude of the first differential pressure, and is set to increase as the target rotational speed of the first hydraulic motor corresponding to the upper limit speed increases. This is the secondary pilot pressure to be applied to the first pilot port of the first hydraulic motor according to the target rotational speed. This may be the output of the primary pressure control valve CV1 according to the first embodiment or the output of the secondary pressure control valve CV2 and the additional secondary pressure control valve ACV2 according to the second embodiment. FIG. 13 shows an example of fourth reference information 10r4 according to the third embodiment. Referring to FIG. 13, when the first differential pressure is up to P0, the target rotational speed of the engine 6 is the target rotational speed r0 of the engine 6 set by the setting member 11. When the first differential pressure is larger than P0, the larger the target rotational speed of the first hydraulic motor is, the more the target rotational speed of the first hydraulic motor is. Target rotational speed of the engine 6 is increased. Specifically, the target rotational speed of the engine 6 changes linearly with respect to the absolute value of the first differential pressure so that the inclination becomes larger as the target rotational speed (upper limit speed) of the first hydraulic motor becomes larger. Although the example of FIG. 13 is a linear function change, other changes may be used as long as the change is a monotonic increase. A range below the lower limit of the upper limit speed designated in FIG. 13 or above the upper limit speed is a speed range that cannot be set by the creep setting member 16. The third reference information 10r3 is information such as a map set for each target rotational speed r0 or an algorithm for obtaining the target rotational speed of the engine 6 relative to the target rotational speed of the first hydraulic motor for each target rotational speed r0. In FIG. 13, 1 km/h designated as the lower limit and 15 km/h designated as the upper limit are examples, and other values may be set. A plurality of speeds may be set between the upper limit and the lower limit. The target rotational speed corresponding to the non-set upper limit speed may be estimated by linear interpolation or the like.

In the present embodiment, the controller 10 is configured to increase the target rotational speed of the engine 6 from the vehicle speed which can be reached in a no-load state when the engine 6 rotates at the engine rotational speed set by the setting member 11 so as to compensate for a speed amount reduced by the load. In other words, the setting member 11 sets the following condition, when a target rotational speed of an engine 6 is a rotational speed capable of achieving an upper limit speed set by a creep setting member 16 and operation lever 55 is operated to a full stroke, a controller 10 refers to fourth reference information 10r4 and controls the target rotational speed of the engine 6, thereby controlling the vehicle speed so as to maintain a target speed (upper limit speed). That is, when the target rotational speed of the engine 6 set by the setting member 11 is a rotational speed capable of achieving the upper limit speed set by the creep setting member 16 and the operation lever 55 is operated in the full stroke, the controller 10 obtains the absolute value of a first differential pressure which is the difference between a first hydraulic pressure and a second hydraulic pressure, and controls the rotational speed of the engine 6 according to the absolute value of the first differential pressure in order to control a vehicle speed to maintain a predetermined target speed (upper limit speed). The controller 10 controls the rotational speed of the engine 6 to increase as the absolute value of the first differential pressure increases. Specifically, the controller 10 controls the rotational speed of the engine 6 to increase as the absolute value of the first differential pressure increases.

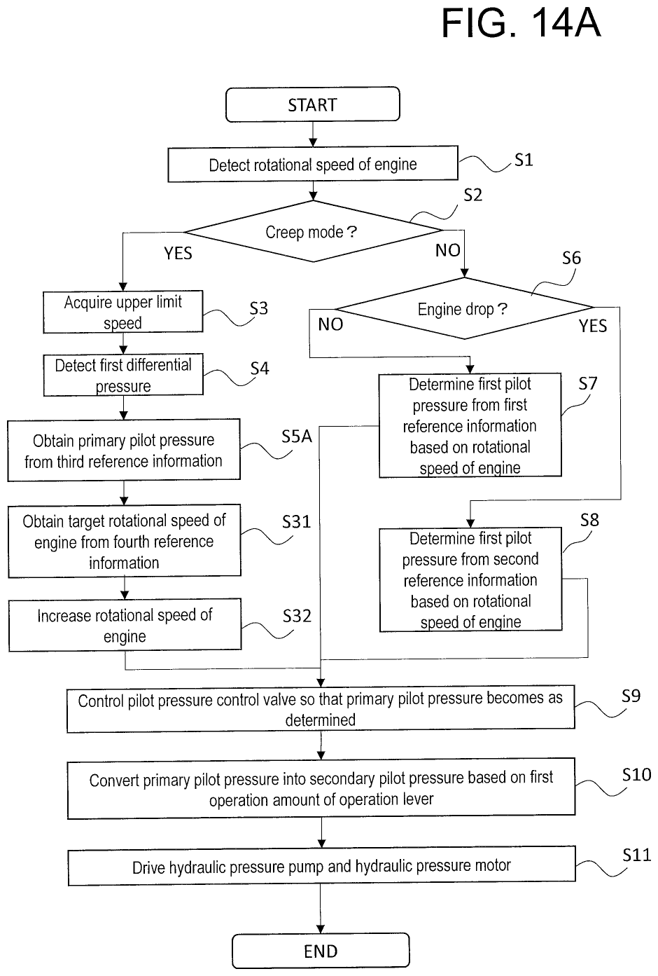

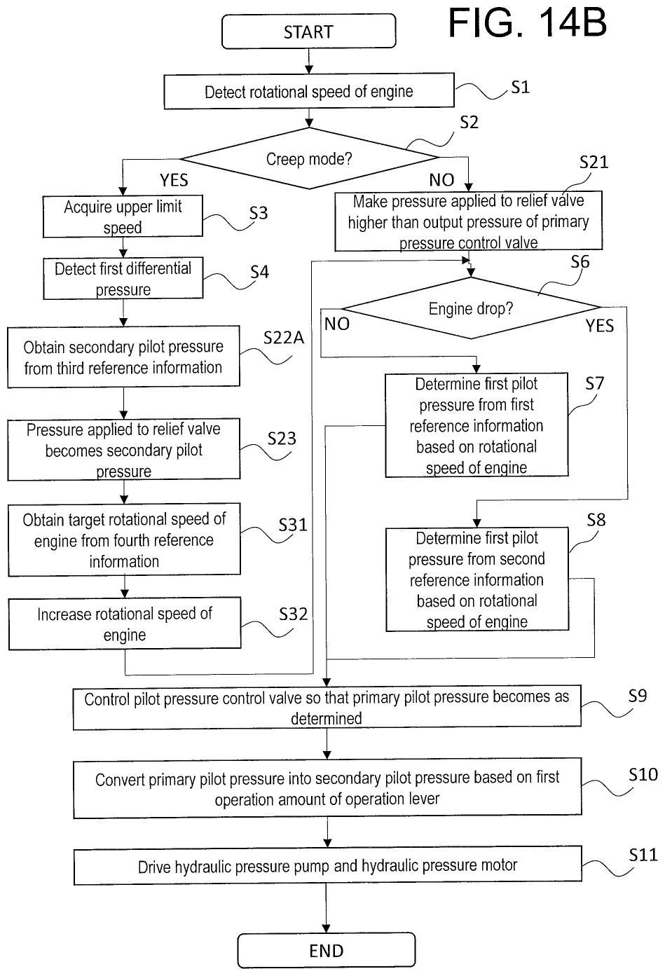

FIGS. 14A and 14B are flowcharts showing the operation of the work vehicle 1 according to the third embodiment. FIG. 14A is a flowchart showing the operation of the work vehicle 1 according to the third embodiment including the hydraulic circuit 1A of the first embodiment. FIG. 14B is a flowchart showing the operation of the work vehicle 1 according to the third embodiment having the hydraulic circuit 1B according to the second embodiment. In FIG. 14A, the same operations as those of the first embodiment are denoted by the same reference numerals, and detailed description thereof will be omitted. In FIG. 14B, the same operations as those of the second embodiment are denoted by the same reference numerals, and detailed description thereof will be omitted.

Referring to FIG. 14A, in step S5A instead of step S5 of the first embodiment, the processor 10a obtains the primary pilot pressure with reference to the third reference information 10r3 as shown in FIG. 12. After step S5A, in step S31, the processor 10a refers to the fourth reference information 10r4 to obtain the target rotational speed of the first hydraulic motor and the target rotational speed of the engine 6 corresponding to the absolute value of the first differential pressure. However, step S5A may be omitted. Next, in step S32, the processor 10a controls the injector, the supply pump, and the common rail so as to increase the rotational speed of the engine 6 based on the obtained target rotational speed.

That is, when the target rotational speed of the engine 6 set by the setting member 11 is a rotational speed capable of achieving the upper limit speed set by the creep setting member 16 and the operation lever 55 is operated in the full stroke, the processor 10a controls the rotational speed of the engine for driving the first hydraulic pump to keep at the predetermined target vehicle speed in accordance with the absolute value of the first differential pressure. Specifically, the processor 10a controls the rotational speed of the engine 6 to increase as the absolute value of the first differential pressure increases. After step S32, the process proceeds to step S9.

Referring to FIG. 14B, in step S22A instead of step S22 of the second embodiment, the processor 10a obtains the secondary pilot pressure with reference to the third reference information 10r3 as shown in FIG. 12. After step S23, steps S31 and S32 described above are executed. After step S32, the process proceeds to step S9. However, steps S22A and S23 may be omitted.

### Operation and Effect of Third Embodiment

In a control method for a work vehicle 1 or a work vehicle 1 according to a third embodiment, a processor 10a acquires an upper limit speed (target rotational speed of a first motor) inputted by a creep setting member 16, acquires an absolute value of a first differential pressure, obtains the upper limit speed from the target rotational speed of an engine 6 corresponding to the acquired absolute value of the first differential pressure, and controls an injector, a supply pump, and a common rail so that the upper limit speed becomes the target rotational speed. By controlling the target rotational speed of the engine 6 by utilizing the variation of the first differential pressure, it is possible to realize an improvement in the user's feeling of use in the creep mode.

### Fourth Embodiment

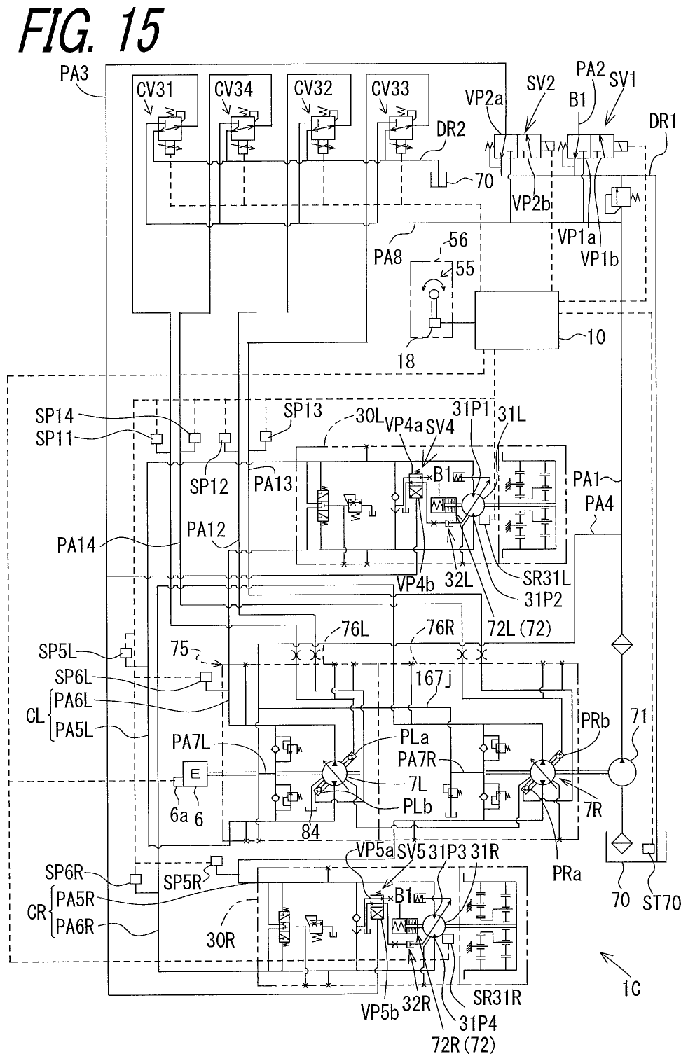

Although the operation lever 55 according to the above-described embodiment directly controls the operation valves OVA, OVB, OVC, and OVD, the work vehicle 1 may control a control valve for controlling the first pump pilot pressure and the second pump pilot pressure based on the operation amount detected by a separate sensor such as a potentiometer, in which the operation amount of the operation lever 55 is detected by the sensor. In this case, the same control as that of the second embodiment can be realized by adjusting the operation amount detected by the sensor. FIG. 15 is a hydraulic circuit diagram of a travel system of the work vehicle 1 according to the fourth embodiment. In FIG. 15, the same components as those in FIG. 3 are denoted by the same reference numerals, and detailed description thereof is omitted. In the fourth embodiment, the work vehicle 1 includes a hydraulic circuit 1C. A hydraulic circuit 1C includes pilot control valves CV31 to CV34 which control the pilot pressure applied to each of the ports (PLa, PRa, PLb, PRb) instead of the operation valves OVA, OVB, OVC, OVD and the first to fourth shuttle valves SVa, SVb, SVc, SVd). The pilot control valves CV31 to CV34 are electromagnetic proportional valves including a solenoid.

In the present embodiment, the pilot supply oil passage PA8 connects the pilot control valves CV31 to CV34 and the pilot supply oil passage PA8, and the first to fourth pilot oil passages PA11 to PA14 are connected to the pilot control valves CV31 to CV34, respectively. In the present embodiment, the pilot supply oil passages PA1 and PA8 and the first to fourth pilot oil passages PA11 to PA14 correspond to a pilot oil supply circuit that connects the pilot pump and the first pump pilot port or the second pump pilot port. In the present embodiment, since there is no operation valves OVA, OVB, OVC, and OVD, there is no difference between the primary pilot pressure and the secondary pilot pressure. Therefore, in the present embodiment, these are simply referred to as pilot pressure without distinguishing them.

In the normal mode, the controller 10 controls pilot control valves CV31 to CV34 control to output the pilot pressure corresponding to FIG. 5 corresponding to the operation position detected by the operation detection sensor 18. In the creep mode, in order to limit the vehicle speed, it is assumed that the operation lever 55 is actually operated at the deemed operation position (converted operation position) Ga even if the operation lever 55 is operated at the full stroke. Specifically, when the operation position is equal to or upper than GA position, it is deemed that the operation is performed at the deemed operation position Ga. In the present embodiment, the operation amount from the G0 position to the Ga position is referred to as the deemed operation amount OA. In this embodiment, the memory 10b includes third reference information 10r3a in place of the third reference information 10r3 according to the first and second embodiments.

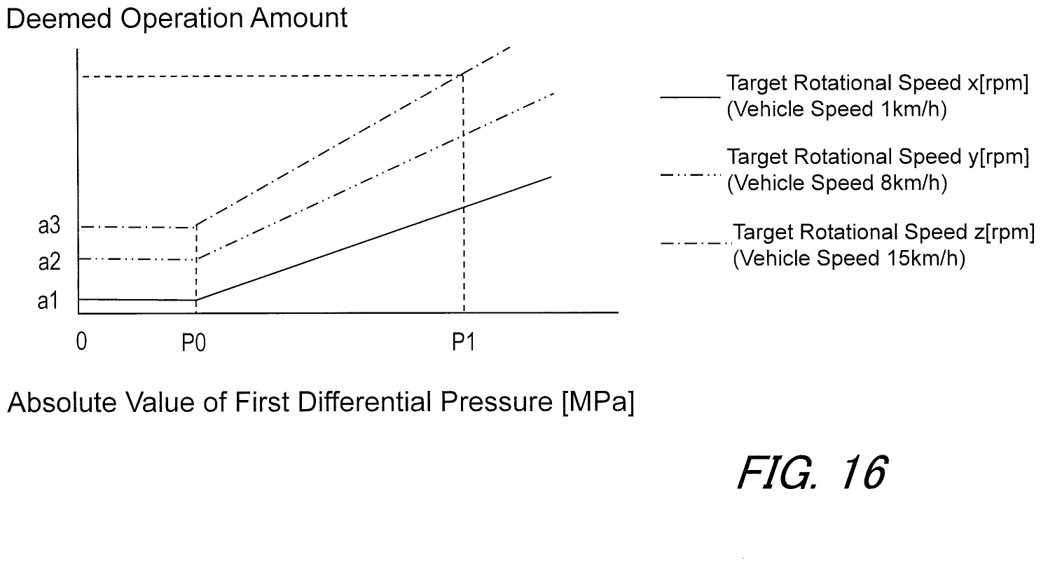

FIG. 16 shows an example of the third reference information 10r3a in the fourth embodiment. The third reference information 10r3a differs from the third reference information 10r3a only in that the vertical axis represents the deemed operation amount OA. When the target rotational speed of the engine 6 set by the setting member 11 is a rotational speed capable of achieving the upper limit speed set by the creep setting member 16, and when the operation lever 55 is operated to the full stroke, referring to the third reference information 10r3a, the controller 10 converts an operation amount detected by an operation detection sensor 18 into a deemed operation amount based on the absolute value of a first differential pressure, and controls a first pump pilot pressure by controlling at least one pilot pressure control valve (pilot control valves CV31 to CV34) in accordance with the deemed operation amount, such that a vehicle speed is controlled to maintain a target speed. That is, when the target rotational speed of the engine 6 set by the setting member 11 is a rotational speed capable of achieving the upper limit speed set by the creep setting member 16 and the operation lever 55 is operated in the full stroke, the controller 10 determines the absolute value of a first differential pressure which is the difference between a first hydraulic pressure and a second hydraulic pressure, and controls the first pump pilot pressure in accordance with the absolute value of the first differential pressure in order to control a vehicle speed to maintain a predetermined target speed. When the target rotational speed of an engine 6 set by a setting member 11 is a rotational speed capable of achieving an upper limit speed set by a creep setting member 16 and operation lever 55 is operated in a full stroke, a controller 10 obtains the absolute value of a second differential pressure which is the difference between a third hydraulic pressure and a fourth hydraulic pressure, and when the absolute value of the first differential pressure is larger than the absolute value of the second differential pressure, the controller 10 controls the second pump pilot pressure according to the absolute value of the first differential pressure in order to control a vehicle speed to maintain a predetermined target speed. As shown in FIG. 16, the controller 10 controls so that the deemed operation amount OA increases as the absolute value of the first differential pressure increases.

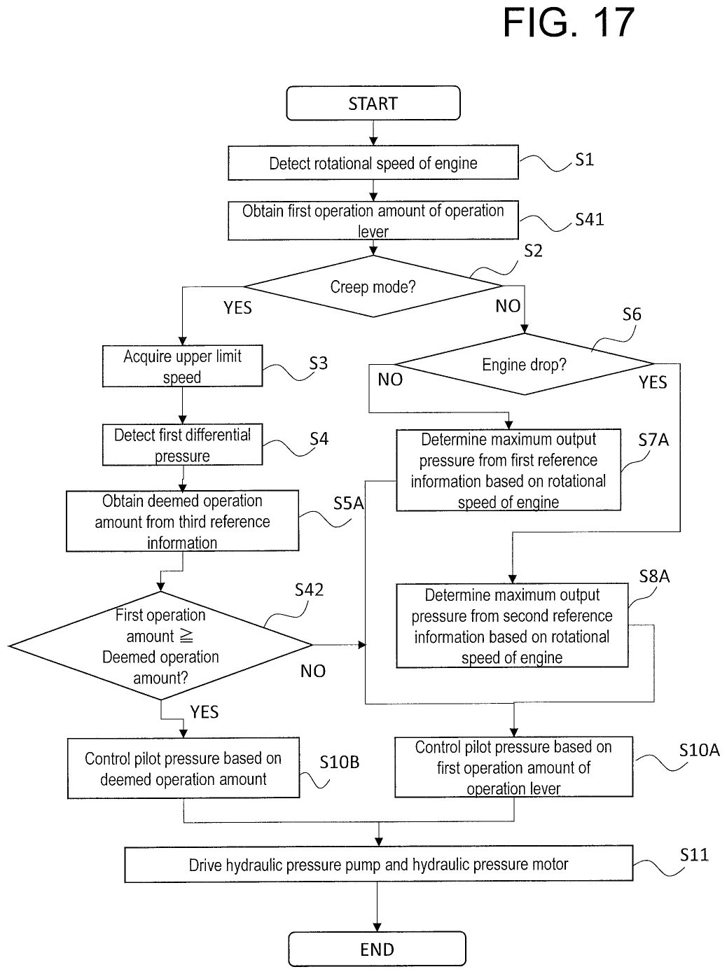

FIG. 17 is a flowchart showing the operation of the work vehicle 1 according to the fourth embodiment. In FIG. 17, the same operations as those of the first embodiment are denoted by the same reference numerals, and detailed description thereof will be omitted. In this flowchart, the processes from step S1 to step S11 are executed at predetermined sampling intervals (e.g., 20 μs). After the end of step S1, the processor 10a acquires the first operation amount from the operation detection sensor 18. When there is no engine drop (No in step S6) in step S7A, the processor 10a determines the maximum output pressure (Pc) shown in FIG. 5 from the first reference information 10r1 based on the rotational speed RS of the engine 6. When there is an engine drop (Yes in step S6), in step S8A the processor 10a determines the maximum output pressure (Pc) from the second reference information 10r2 based on the rotational speed RS of the engine 6. After the completion of step S7A or step SBA, in step 10a, the processor 10a determines the pilot pressure according to the first operation amount in a state where the maximum output pressure (Pc) is limited, and controls the pilot control valves CV31 to CV34 so that the determined pilot pressure is applied.

After the end of step S4, in step S5A, the processor 10a refers to the third reference information 10r3a and obtains the trial operation amount based on the absolute value of the first differential pressure. Then, in step S42, the processor 10a determines whether or not the first operation amount is equal to or greater than the deemed operation amount. In the creep mode, the operation is normally performed so that the first operation amount is equal to or larger than the deemed operation amount. According to steps S41, S5A, and S42, the processor 10a detects an operation amount of the travel instruction input device (operation lever) 55, and converts the detected operation amount into the deemed operation amount based on the absolute value of the first differential pressure. When the first operation amount is equal to or greater than the deemed operation amount OA (Yes in step S42), in step 10B, the processor 10a determines the pilot pressure according to the deemed operation amount, and controls the pilot control valves CV31 to CV34 so that the determined pilot pressure is applied. In other words, the processor 10a controls the first pump pilot pressure and the second pump pilot pressure based on the deemed operation amount. As described above, when the target rotational speed of the engine 6 set by the setting member 11 is a rotational speed capable of achieving the upper limit speed set by the creep setting member 16 and the operation lever 55 is operated in the full stroke, the processor 10a controls the first pump pilot pressure applied to the first pump pilot port of the first hydraulic pump in order to control a vehicle speed to maintain a predetermined target speed according to the absolute value of the first differential pressure. When the target rotational speed of an engine 6 set by a setting member 11 is a rotational speed capable of achieving an upper limit speed set by a creep setting member 16 and when operation lever 55 is operated in a full stroke, a processor 10a controls a second pump pilot pressure applied to a second pump pilot port of a second hydraulic pump in accordance with the absolute value of the first differential pressure and in accordance with the absolute value of the first differential pressure in order to control a vehicle speed to maintain a predetermined target speed when the absolute value of the first differential pressure is greater than the absolute value of the second differential pressure.

### Operation and Effect of Fourth Embodiment

In a control method for a work vehicle 1 or a work vehicle 1 according to a fourth embodiment, a processor 10a acquires an upper limit speed (target rotational speed of a first motor) inputted by a creep setting member 16, acquires an absolute value of a first differential pressure, obtains the upper limit speed from an deemed operation amount corresponding to the acquired target rotational speed and the absolute value of the first differential pressure, and applies a pilot pressure based on the upper limit speed to a first pump pilot port. By controlling the pilot pressure using the variation of the first differential pressure, it is possible to realize an improvement in the user's feeling of use in the creep mode.

### Modified Example of Fourth Embodiment

In the fourth embodiment, when the absolute value of the first differential pressure is larger than the absolute value of the second differential pressure, the processor 10a controls the second pump pilot pressure applied to the second pump pilot port of the second hydraulic pump according to the absolute value of the first differential pressure. However, when the difference between the absolute value of the first differential pressure and the absolute value of the second differential pressure is within a predetermined range, the processor 10a may control the second pump pilot pressure according to the absolute value of the second differential pressure. In this case, the absolute value of the first differential pressure in FIG. 16 is replaced with the absolute value of the second differential pressure, and the processor 10a may control the additional secondary pressure control valve ACV based on the deemed operation amount of only the vertical axis. Thus, when the absolute value of the first differential pressure is not significantly different from the absolute value of the second differential pressure, the left and right traveling devices are separately controlled so that an operation such as turning close to the user's desire can be realized. Further, in the second embodiment, the operation detection sensor 18 may be provided in the travel instruction input device (operation lever) 55, the above-described deemed operation amount may be calculated based on the detection result of the operation detection sensor 18, and the above-described control of the secondary pressure control valve CV2 and the additional secondary pressure control valve ACV2 may be performed according to the calculation result. In this case, since the relief valves CV23 and CV24 are controlled using the deemed operation amount, the work vehicle 1 can be controlled to obtain a desired vehicle speed more quickly than when the control is performed by the pilot control valves CV31 to CV34 which are electromagnetic proportional valves as shown in FIG. 19.

### Modifications According to All Embodiments

The values of the various threshold values may be changed according to characteristics of the left hydraulic pump 7L, the right hydraulic pump 7R, the left hydraulic motor 31L, and the right hydraulic motor 31R, characteristics of a reduction gear connected to the left hydraulic motor 31L, characteristics of a reduction gear connected to the right hydraulic motor 31R, and characteristics of various control valves.

The term “comprising” and derivatives thereof are non-limiting terms describing the presence of an element and do not exclude the presence of other elements not described. This also applies to “have,” “include,” and derivatives thereof.

The terms “member”, “part”, “element”, “body”, and “structure” may have multiple meanings, such as a single part or a plurality of parts.

Ordinal numbers such as “first” and “second” are merely terms used to identify the structure and have no other meaning (e.g., a particular order). For example, the existence of the “first element” does not imply the existence of the “second element”, and the existence of the “second element” does not imply the existence of the “first element”.

Terms such as “substantially”, “about”, and “approximately” to indicate the degree may mean a reasonable amount of deviation such that the final result does not change significantly, unless otherwise stated in the embodiments. All numerical values set forth herein may be construed to include words such as “substantially”, “about”, and “approximately”.

In this application, the phrase “at least one of A and B” should be interpreted to include only A, only B, and both A and B.

It is apparent from the above disclosure that various modifications and modifications of the present invention are possible. Accordingly, the present invention may be carried out by a method different from the specific disclosure of the present application without departing from the spirit of the present invention.

What is claimed is:

1. A speed control method for a work vehicle, comprising:
controlling a first hydraulic pump to supply hydraulic fluid to a first hydraulic motor to drive a first traveling device provided on a vehicle body of the work vehicle;
detecting a first differential pressure of the first hydraulic motor; and
regulating at least one of a first pump pilot pressure applied to a first pump pilot port of the first hydraulic pump and a rotational speed of an engine to drive the first hydraulic pump such that a vehicle speed is controlled to maintain a predetermined target speed in response to an absolute value of the first differential pressure.

2. The speed control method according to claim 1,
wherein regulating the first pump pilot pressure comprises at least one of:
regulating a primary pilot pressure which is a hydraulic pressure of a primary pilot oil passage connecting a pilot pump to discharge pilot oil toward the first pump pilot port and an operation valve controlled according to an input to a travel instruction input device to which an instruction of a traveling direction is input by a user;
regulating a secondary pilot pressure which is the hydraulic pressure of a secondary pilot oil passage connecting the operation valve and the first pump pilot port; and
detecting an operation amount of the travel instruction input device to convert the operation amount into a converted operation amount based on the absolute value of the first differential pressure to regulate the first pump pilot pressure based on the converted operation amount.

3. The speed control method according to claim 1, wherein
the regulating at least one of a first pump pilot pressure and the rotational speed of the engine includes increasing the at least one of the first pump pilot pressure and the rotational speed of the engine as an absolute value of the first differential pressure increases.

4. The speed control method according to claim 1, further comprising:
controlling a second hydraulic pump to supply hydraulic fluid to a second hydraulic motor to drive a second traveling device provided on the vehicle body opposite to the first traveling device;
detecting a second differential pressure of the second hydraulic motor; and
regulating at least one of a second pump pilot pressure applied to a second pump pilot port of the second hydraulic pump and a rotational speed of the engine to drive the second hydraulic pump such that the vehicle speed is controlled to maintain at the predetermined target speed in response to the absolute value of the first differential pressure.

5. The speed control method according to claim 4,
wherein regulating the second pump pilot pressure comprises at least one of:
regulating a primary pilot pressure which is a hydraulic pressure of a primary pilot oil passage connecting a pilot pump to discharge pilot oil to the second pump pilot port and an operation valve controlled according to an input to a travel instruction input device to which an instruction of a traveling direction is input by a user;
regulating a secondary pilot pressure which is the hydraulic pressure of a secondary pilot oil passage connecting the operation valve and the second pump pilot port; and
detecting an operation amount of the travel instruction input device to convert the operation amount into the converted operation amount based on the absolute value of the first differential pressure to regulate a second pump pilot pressure based on the converted operation amount.

6. The speed control method according to claim 4, wherein
the regulating at least one of a first pump pilot pressure and the rotational speed of the engine includes increasing the at least one of the second pump pilot pressure and the rotational speed of the engine as the absolute value of the first differential pressure increases.

7. A work vehicle comprising:
a vehicle body;
a first traveling device provided on the vehicle body;
a first hydraulic motor having a first motor pilot port and configured to drive the first traveling device in response to a first motor pilot pressure applied to the first motor pilot port;
a first hydraulic pump having a first pump pilot port and configured to supply hydraulic fluid to the first hydraulic motor in response to a first pump pilot pressure applied to the first pump pilot port;
a first oil passage and a second oil passage which connect the first hydraulic pump and the first hydraulic motor and through which the hydraulic fluid is supplied;
a first hydraulic pressure sensor configured to detect a first hydraulic pressure in the first oil passage;
a second hydraulic pressure sensor configured to detect a second hydraulic pressure in the second oil passage;
a pilot pump configured to supply pilot oil to the first pump pilot port;
an engine configured to drive the first hydraulic pump and the pilot pump; and
control circuitry configured to obtain an absolute value of a first differential pressure, which is a difference between the first hydraulic pressure and the second hydraulic pressure, the control circuitry being configured to regulate at least one of the first pump pilot pressure and a rotational speed of the engine such that a vehicle speed is controlled to maintain a predetermined target speed according to the absolute value of the first differential pressure.

8. The work vehicle according to claim 7,
wherein the rotational speed of the engine is increased as the absolute value of the first differential pressure increases.

9. The work vehicle according to claim 7, further comprising:
a travel instruction input device to which an instruction of a traveling direction is input by a user;
an operation valve configured to be operated by the travel instruction input device to regulate the first pump pilot pressure; and
a primary pilot oil passage connecting the pilot pump and the operation valve; and
a primary pressure control valve provided in the primary pilot oil passage and configured to regulate a primary pilot pressure which is a hydraulic pressure of the pilot oil in the primary pilot oil passage, the primary pilot pressure being an upper limit of the first pump pilot pressure;
the control circuitry being configured to control the primary pressure control valve to regulate the primary pilot pressure such that the vehicle speed is controlled to maintain the target speed.

10. The work vehicle according to claim 9,
wherein the primary pilot pressure is regulated to be increased as the absolute value of the first differential pressure increases.

11. The work vehicle according to claim 7, further comprising:
a traveling instruction input device to which an instruction of a traveling direction is input by a user;
an operation valve configured to be operated by the travel instruction input device to regulate the first pump pilot pressure;
a secondary pilot oil passage connecting the operation valve and the first pump pilot port;
a secondary pressure control valve provided in the secondary pilot oil passage and configured to regulate a secondary pilot pressure which is a hydraulic pressure of the pilot oil in the secondary pilot oil passage; and
the control circuitry being configured to control the secondary pressure control valve to convert the first pump pilot pressure to the secondary pilot pressure such that the vehicle speed is controlled to maintain the target speed.

12. The work vehicle according to claim 11,
wherein the secondary pilot pressure is regulated to be increased as the absolute value of the first differential pressure increases.

13. The work vehicle according to claim 7, further comprising:
a traveling instruction input device to which an instruction of a traveling direction is input by a user;
an operation detection sensor configured to detect an operation amount of the travel instruction input device;
a pilot oil supply circuit connecting a pilot pump and the first pump pilot port; and
at least one pilot pressure control valve provided on the pilot oil supply circuit and configured to regulate a hydraulic pressure of the pilot oil;
the control circuitry being configured to convert the operation amount detected by the operation detection sensor into a converted operation amount based on the absolute value of the first differential pressure; and
the control circuitry being configured to control the at least one pilot pressure control valve to regulate the first pump pilot pressure such that the vehicle speed is controlled to maintain the target speed according to the converted operation amount.

14. The work vehicle according to claim 13,
wherein the converted operation amount is regulated to be increased as the absolute value of the first differential pressure increases.

15. The work vehicle according to claim 7, further comprising:
a second traveling device provided on the vehicle body opposite to the first traveling device;
a second hydraulic motor having a second motor pilot port and configured to drive a second traveling device according to a second motor pilot pressure applied to the second motor pilot port;
a second hydraulic pump having a second pump pilot port and configured to supply hydraulic fluid to the second hydraulic motor in response to a second pump pilot pressure applied to the second pump pilot port;
a third oil passage and a fourth oil passage which connect the second hydraulic pump and the second hydraulic motor and through which the hydraulic fluid is supplied;
a third hydraulic pressure sensor configured to detect a third hydraulic pressure in the third oil passage
a fourth hydraulic pressure sensor configured to detect a fourth hydraulic pressure in the fourth oil passage;
the engine being configured to drive the second hydraulic pump;
the pilot pump being configured to supply the pilot oil to the second pump pilot port;
the control circuitry being configured to obtain an absolute value of a second differential pressure which is a difference between the third hydraulic pressure and the fourth hydraulic pressure; and
the control circuitry being configured to regulate at least one of the second pump pilot pressure and the rotational speed of the engine according to the absolute value of the first differential pressure such that the vehicle speed is controlled to maintain the predetermined target speed when the absolute value of the first differential pressure is larger than the absolute value of the second differential pressure.

16. The work vehicle according to claim 15,
wherein the second pump pilot pressure is regulated to be increased as the absolute value of the first differential pressure increases.
